(19) United States
(12) Patent Application Publication
(10) Pub. No.: US 2025/0106337 A1
(43) Pub. Date: Mar. 27, 2025

(54) INFORMATION PROCESSING APPARATUS, CONTROL METHOD, STORAGE MEDIUM, AND SYSTEM

(71) Applicant: CANON KABUSHIKI KAISHA, Tokyo (JP)

(72) Inventors: HIROAKI KOBAYASHI, Tokyo (JP); KANTA KUMAGAI, Kanagawa (JP)

(21) Appl. No.: 18/898,057

(22) Filed: Sep. 26, 2024

(30) Foreign Application Priority Data
Sep. 27, 2023 (JP) 2023-165667
Sep. 27, 2023 (JP) 2023-165668

(51) Int. Cl. H04N 1/00

(52) U.S. Cl. CPC H04N 1/00824; H04N 1/00214; H04N 1/00244; H04N 1/0044

(57) ABSTRACT

A control method for an information processing apparatus, the information processing apparatus being capable of communicating with a server, the server being capable of communicating with an image processing apparatus, the method comprising: receiving setting of information about scanning; transmitting, to the server, scan-job setting information based on the received setting of information about scanning; and acquiring scan data from the server, the scan data being generated through the scanning performed by the image processing apparatus based on the scan-job setting information, wherein the acquired scan data is displayed in a predetermined area on a display unit of the information processing apparatus.

### BACKGROUND

### Field

The present disclosure relates to an information processing apparatus, a control method, a storage medium, and a system.

### Description of the Related Art

Recently, communication using a chat function is known. For example, there is an application program called a collaboration tool which enables collaborative work on a network. In addition, an enhanced application program called a plug-in may be introduced to a collaboration tool. Japanese Patent Laid-Open No. 2021-83019 describes a function related to an enhanced application introduced to a collaboration tool.

It has been demanded that user convenience of a function related to an enhanced application introduced to a collaboration tool be further improved.

### SUMMARY

According to an aspect of the present disclosure, a control method for an information processing apparatus, the information processing apparatus being capable of communicating with a server, the server being capable of communicating with an image processing apparatus, the method comprising: receiving setting of information about scanning; transmitting, to the server, scan-job setting information based on the received setting of information about scanning; and acquiring scan data from the server, the scan data being generated through the scanning performed by the image processing apparatus based on the scan-job setting information, wherein the acquired scan data is displayed in a predetermined area on a display unit of the information processing apparatus.

Further features of the present disclosure will become apparent from the following description of exemplary embodiments with reference to the attached drawings.

### BRIEF DESCRIPTION OF THE DRAWINGS

FIG. 1 is a diagram illustrating the configuration of an information processing system.

FIG. 2 is a block diagram illustrating the hardware configuration of an information processing apparatus.

FIG. 3 is a block diagram illustrating the software configuration of an information processing apparatus.

FIG. 4 is a block diagram illustrating the hardware configuration of a multi-function peripheral (MFP).

FIG. 5 is a block diagram illustrating the software configuration of an MFP.

FIG. 6 is a block diagram illustrating the hardware configuration of a collaboration-tool information management server.

FIG. 7 is a block diagram illustrating the software configuration of a collaboration-tool information management server.

FIG. 8 is a flowchart of a process of registering device information of an MFP.

FIGS. 9A and 9B are a flowchart of a process in which scan-job setting information is registered and which is performed by an information processing apparatus.

FIG. 10 is a diagram illustrating an example of users/teams/channels.

FIG. 11 is a diagram illustrating exemplary context information.

FIGS. 12A and 12B are diagrams illustrating screens displayed on a display unit of an information processing apparatus: FIG. 12A illustrates a job setting screen; FIG. 12B illustrates a screen for prompting a process on an MFP.

FIGS. 13A and 13B are a flowchart of a process of a collaboration-tool information management server receiving an event.

FIG. 14 is a flowchart of a process of displaying a job list on a display unit of an MFP.

FIG. 15 is a diagram illustrating exemplary data stored in a collaboration-tool information management server.

FIGS. 16A and 16B are a flowchart of a process of an MFP executing a job.

FIGS. 17A to 17K are diagrams illustrating exemplary screens displayed on an MFP.

FIGS. 18A and 18B are a flowchart of a process of making transitions automatically between screens displayed on a display unit of an information processing apparatus.

FIGS. 19A and 19B are diagrams illustrating exemplary preview screens displayed on a display unit of an information processing apparatus.

FIG. 20 is a diagram illustrating exemplary chat room screens displayed on a display unit of an information processing apparatus.

FIG. 21 is a diagram illustrating exemplary data stored in an MFP.

FIGS. 22A and 22B are a flowchart of a process in which scan-job setting information is registered and which is performed by an information processing apparatus.

FIGS. 23A and 23B are diagrams illustrating exemplary job setting screens displayed on a display unit of an information processing apparatus.

### DESCRIPTION OF THE EMBODIMENTS

The present disclosure will be described below in detail by referring to the drawings. Embodiments described below do not limit the present disclosure describing the scope of claims. All combinations of features described in the present embodiments are not necessarily essential for the solution described in the present disclosure. In the attached drawings, the same reference numerals are assigned to the same or similar configurations, and repeated description will be avoided.

### First Embodiment

An enhanced application called a plug-in introduced to a collaboration tool may be invoked, for example, from a predetermined area in a chat area of the collaboration tool or an area, in which an enhanced application is selectable, in a menu area for selecting a function or a chat room of the collaboration tool. The predetermined area in a chat area refers, for example, to an object, such as an icon or a button. The area, in which an enhanced application is selectable, in a menu area refers, for example, to an icon button. A chat area and a menu area for selecting a function of the collaboration tool are displayed in the same predetermined screen, or may be displayed on different screens. An enhanced application serves as an information processing system which is capable of submitting a scan job to an external image processing apparatus and posting, to a posting destination specified on the collaboration tool, the scan result (scan data) obtained through scanning on the image processing apparatus.

In such an information processing system, when scanning is performed by the image processing apparatus to generate scan data, the scan data is posted automatically to a predetermined posting destination on the collaboration tool.

However, when the generated scan data is data which is not intended by a user, the unintended scan data may be posted automatically to the predetermined posting destination on the collaboration tool. For example, when an image, which is not intended by a user, is scanned, the unintended scan data may be posted to the predetermined posting destination. In addition, for example, when a setting value, which is not intended by a user, is used in scanning, the unintended scan data may be posted to the predetermined posting destination.

Accordingly, in the present embodiment, before scan data is posted to a predetermined posting destination, a preview image of the scan data is displayed on a collaboration tool. After display of the preview image of the scan data, a posting instruction is allowed to be received. Thus, the scan data is posted to the predetermined posting destination.

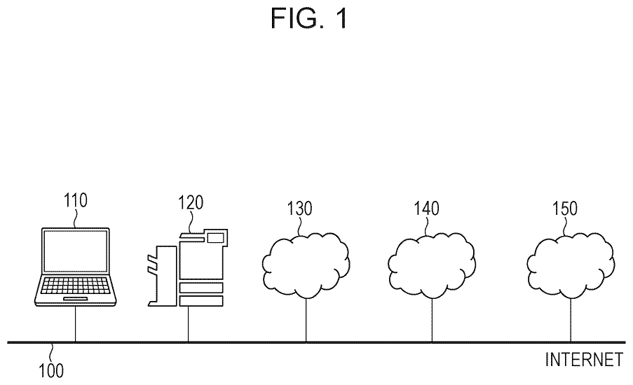

Thus, when generated scan data is data which is not intended by a user, occurrence of posting the unintended scan data automatically to a predetermined posting destination on a collaboration tool may be reduced. By using FIG. 1, the configuration of a communication system provided by the present disclosure will be described. The system configuration according to the present embodiment includes an information processing apparatus 110, an image processing apparatus 120, a collaboration-tool information management server 130, a data server 140, and a collaboration tool server 150. The data server 140 is a server (an external server of the collaboration-tool information management server 130) to which the collaboration-tool information management server 130 uploads data. For example, in the present embodiment, a scan result file generated by the image processing apparatus 120 is uploaded to the data server 140. The collaboration tool server 150 is a server (an external server of the collaboration-tool information management server 130) which is constructed and managed by an external vendor which provides the collaboration tool. For example, in the present embodiment, the collaboration-tool information management server 130 transmits, to the collaboration tool server 150, an instruction to post data to an enhanced application. The data server 140 and the collaboration tool server 150 will not be described in detail.

In the system illustrated in FIG. 1, the information processing apparatus 110, the MFP 120, the collaboration-tool information management server 130, the data server 140, and the collaboration tool server 150 perform communication through the Internet 100. Examples of a communication system which is used in communication between the apparatuses include a communication standard (Wi-Fi) of IEEE802.11 series and Bluetooth (such as Bluetooth Classic and Bluetooth Low Energy (BLE)). In the system according to the present embodiment, the apparatuses may be connected directly. Alternatively, communication between the apparatuses may be performed through Internet communication by way of a wireless local-area network (LAN) router. Alternatively, the apparatuses may communicate through mobile communication (3rd generation (3G) or 4th generation (4G), 5th generation (5G)).

The information processing apparatus 110, the collaboration-tool information management server 130, the data server 140, and the collaboration tool server 150 are, for example, personal computers (PCs). However, the configuration is not limited to this, and various devices, such as a smartphone, a tablet terminal, and a digital camera, may be used as the information processing apparatus 110, the collaboration-tool information management server 130, and the data server 140 according to the present embodiment. The image processing apparatus 120 may be, for example, a printing device (printer). The printing device refers to a device having a recording device provided with a print function of recording information on a print medium by using a recording material. In addition, for example, the image processing apparatus 120 may be a device which further includes a reading device which reads an image on a document and which serves as a copier, or a multi-function peripheral (MFP) having other additional functions. The print system of the image processing apparatus 120 may be an electrophotographic system, an inkjet system, or another system. For the image processing apparatus 120, for example, various devices, such as a PC, a smartphone, a tablet terminal, and a digital camera, may be used as the image processing apparatus 120 according to the present embodiment. Hereinafter, the image processing apparatus 120 is referred to as the MFP 120.

A collaboration tool application 301, which accesses the collaboration tool server 150 to provide a chat function, is installed in the information processing apparatus 110, and is operable in the information processing apparatus 110. The collaboration tool application 301 is capable of performing a Web application (enhanced application) 701 as a plug-in which enables an enhancement, and is capable of generating information of a scan job which is to be executed by the MFP 120. That is, the Web application (enhanced application) 701 is capable of operating in the information processing apparatus 110. The MFP 120 communicates with the collaboration-tool information management server 130 to receive/transmit information about the collaboration tool, and performs scanning on the basis of information about a received scan job. The collaboration-tool information management server 130 provides Web content for use in the collaboration tool application 301 of the information processing apparatus 110. In addition, the collaboration-tool information management server 130 stores information about a scan job generated by the information processing apparatus, temporarily stores a scan result file obtained through scanning on the MFP 120, and stores scan capability values of the MFP 120. Further, the collaboration-tool information management server 130 provides the stored file to the information processing apparatus 110 or the MFP 120, and transmits data to the data server 140 or the collaboration tool server 150. The data server 140 stores a scan result file obtained through scanning on the MFP 120. In addition, the data server 140 provides the link to a stored file to the chat function of the collaboration tool server 150 to implement posting of a chat message, which involves the file. The collaboration tool server 150 provides functions, related to chatting, to the information processing apparatus 110 or the collaboration-tool information management server 130.

In the present embodiment, description will be made by taking, as an example, a form in which scan job information is received/transmitted in communication between the apparatuses in the system in FIG. 1. The configuration is not limited to scan job information. Any information may be employed as long as the present embodiment may be carried out by using the information.

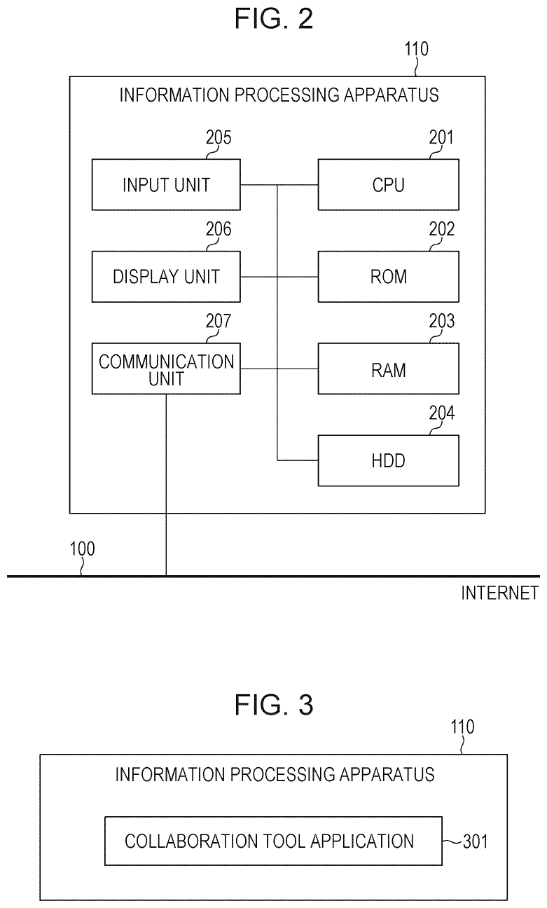

By using FIG. 2, the hardware configuration of the information processing apparatus 110 will be described. The information processing apparatus 110 according to the present embodiment is assumed to be an apparatus, such as a PC, a smartphone, or a tablet. Any other apparatus may be employed as long as it is an information processing apparatus which is capable of communicating with the Internet 100.

A central processing unit (CPU) 201 reads control programs stored in a read-only memory (ROM) 202, and performs various processes for controlling operations of the information processing apparatus 110. The ROM 202 stores control programs. A random-access memory (RAM) 203 is used as a temporary storage area, such as a main memory and a work area, of the CPU 201. A hard disk drive (HDD) 204 stores various data, such as photographs and electronic documents. The collaboration tool application 301 described below is also stored in the HDD 204. An input unit 205 receives input on the information processing apparatus 110. The input may be performed by using an external terminal, or may be performed by using a unit attached to the information processing apparatus, such as a touch panel. A display unit 206 displays various screens. The display unit 206 may have a touch panel function which is capable of detecting a user's touch operation. A communication unit 207 performs telecommunication by using the Internet 100.

By using FIG. 3, the software configuration of the information processing apparatus 110 will be described. FIG. 3 is a functional block diagram for describing software implemented by the CPU 201 reading control programs stored in the ROM 202 and the HDD 204. The collaboration tool application 301 may use the collaboration tool through communication with the collaboration tool server 150, and allows communication with people by using chats. In addition, the collaboration tool application 301 may read, onto the RAM 203, a manifest file, which is stored in the HDD 204, to perform the Web application 701, described below, as a plug-in which enables an enhancement of the collaboration tool.

The information processing apparatus 110 may use various applications other than the collaboration tool, which are not described.

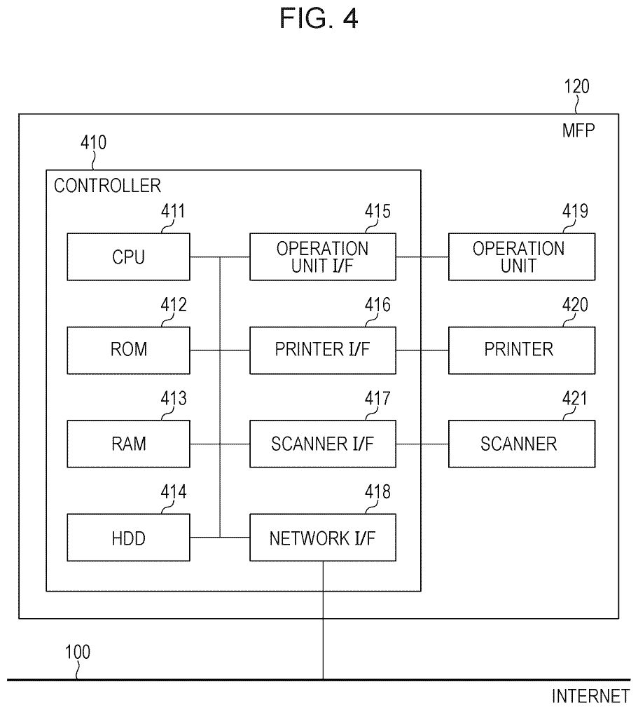

By using FIG. 4, the hardware configuration of the MFP 120 will be described. A controller 410 including a CPU 411 controls the operations of the entire apparatus. The CPU 411 reads control programs, which are stored in a ROM 412 and an HDD 414, to perform various control processes. A RAM 413 is used as a temporary storage area, such as a main memory and a work area, of the CPU 411. The HDD 414 stores various programs and data. An operation unit I/F 415 connects an operation unit 419 to the controller 410. The operation unit 419 includes a liquid-crystal display having a touch panel function. A printer I/F 416 connects a printer 420 to the controller 410. A scanner I/F 417 connects a scanner 421 to the controller 410. A network I/F 418 connects the controller 410 to the Internet 100.

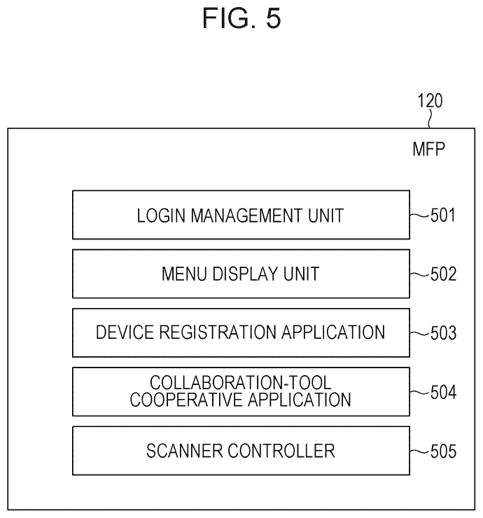

By using FIG. 5, the software configuration of the MFP 120 will be described. The CPU 411 reads programs, which are stored in the HDD 414 of the MFP 120, onto the RAM 413 for analysis and execution. Thus, the processes described below are performed. A login management unit 501 manages user authentication in the MFP 120. A menu display unit 502 displays menu screens on the operation unit 419. The menu display unit 502 displays buttons (hereinafter referred to application buttons) for invoking applications on the menu screens. The application buttons are buttons for invoking various functions, such as applications installed in the MFP 120 and Web applications. A device registration application 503 registers information about the MFP 120 in the collaboration-tool information management server 130. A collaboration-tool cooperative application 504 accesses the collaboration-tool information management server 130 to display Web content. A scanner controller 505 scans documents through operations on the scanner I/F 417.

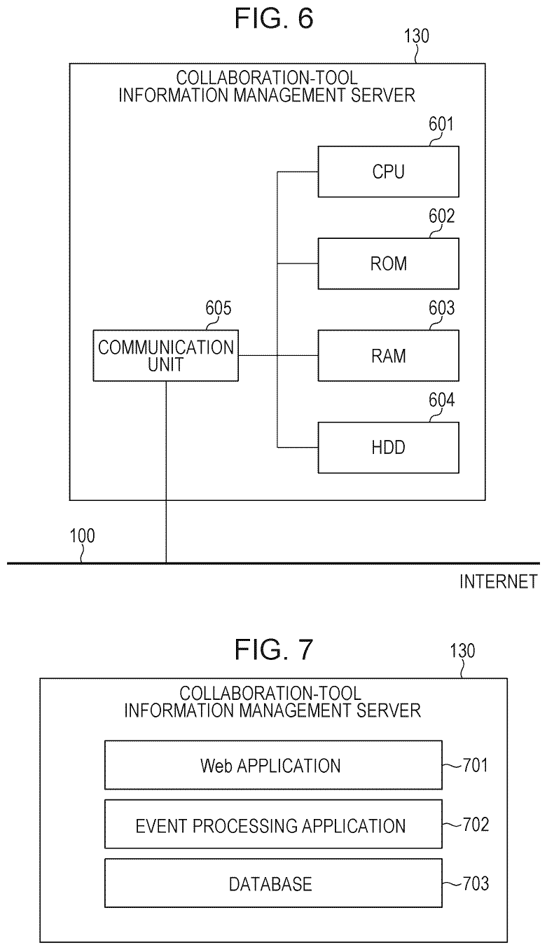

By using FIG. 6, the hardware configuration of the collaboration-tool information management server 130 will be described.

A CPU 601 reads control programs, which are stored in a ROM 602, to perform various processes for controlling operations of the collaboration-tool information management server 130. The ROM 602 stores control programs. A RAM 603 is used as a temporary storage area, such as a main memory and a work area, of the CPU 601. An HDD 604 stores various data, such as photographs and electronic documents. A communication unit 605 performs telecommunication using the Internet 100.

By using FIG. 7, the software configuration of the collaboration-tool information management server 130 will be described.

FIG. 7 is a functional block diagram for describing software implemented by the CPU 601 reading control programs stored in the ROM 602 and the HDD 604. The Web application 701 is an application which is capable of generating scan job settings used in scanning on the MFP 120. The Web application 701 is an application which is read, operated, and performed by the collaboration tool application 301. An event processing application 702 is an application which performs processes for events transmitted to the collaboration-tool information management server 130. A database 703 manages information used by the Web application 701 and the event processing application 702. The information is held in the HDD 604.

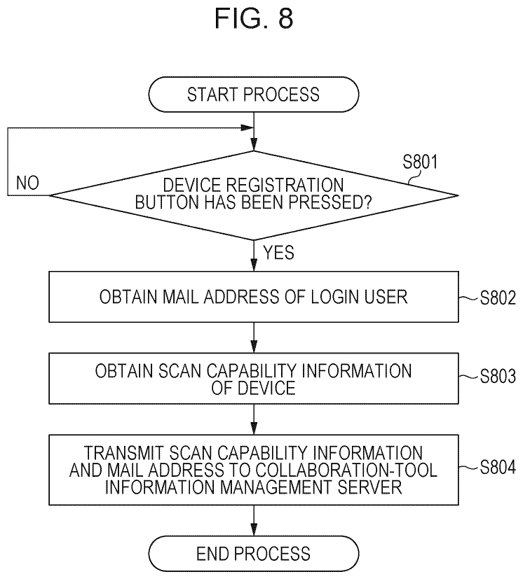

FIG. 8 is a flowchart of an exemplary process performed so that, in the MFP 120, the device registration application 503 uploads device capability information of the MFP 120 to the collaboration-tool information management server 130, and registers the MFP 120 as a device which is to be used by a login user.

Hereinafter, a user who has logged in the MFP 120 is referred to as a login user.

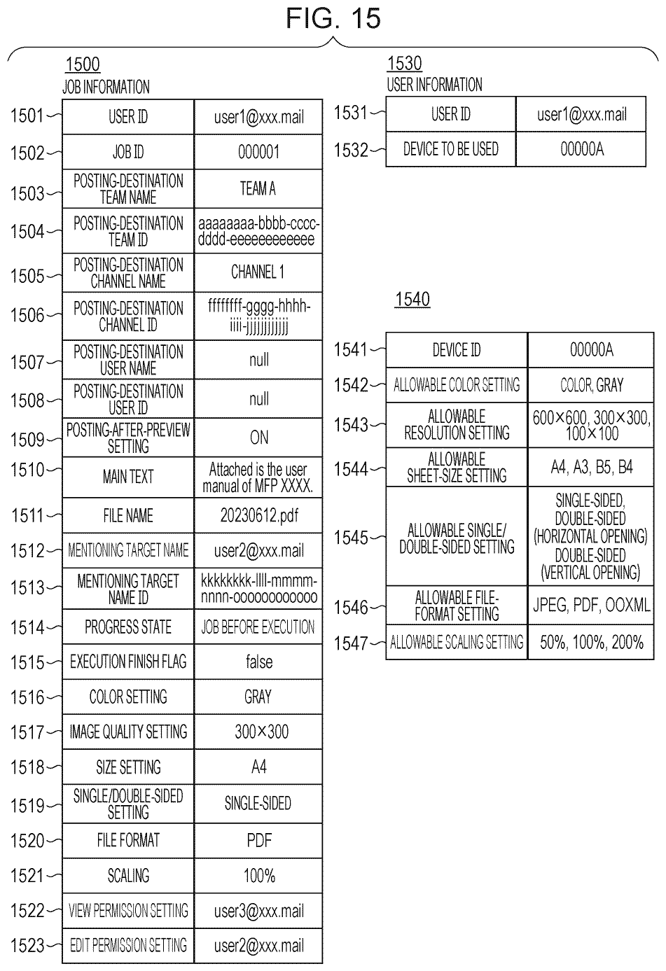

FIG. 15 illustrates exemplary data on a collaboration-tool information management server.

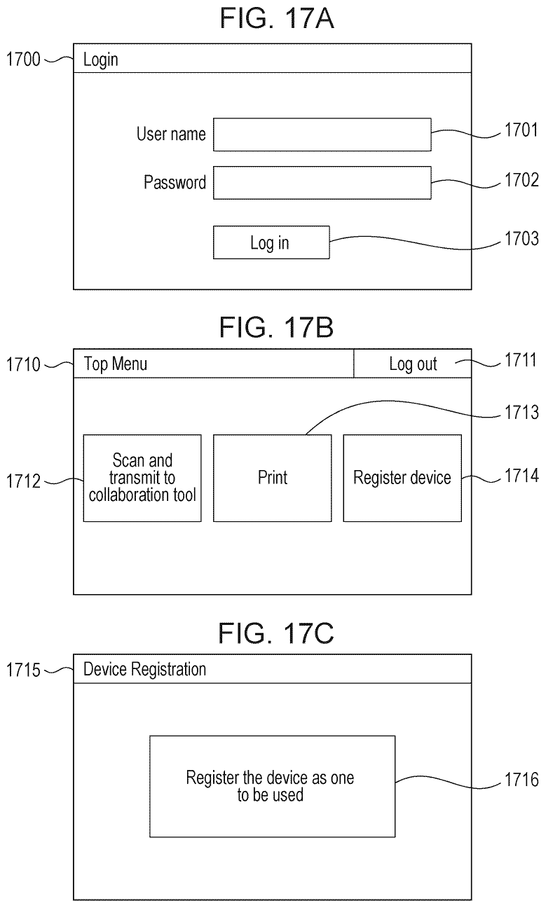

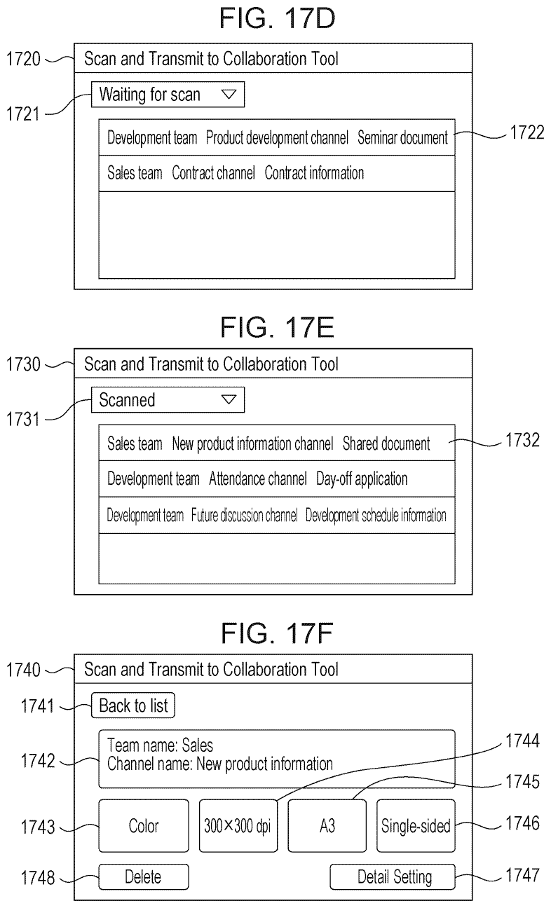

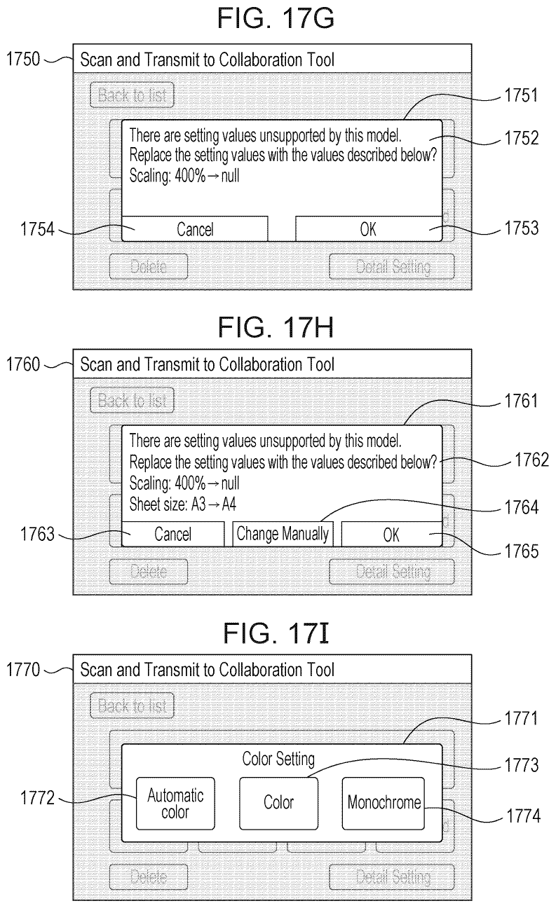

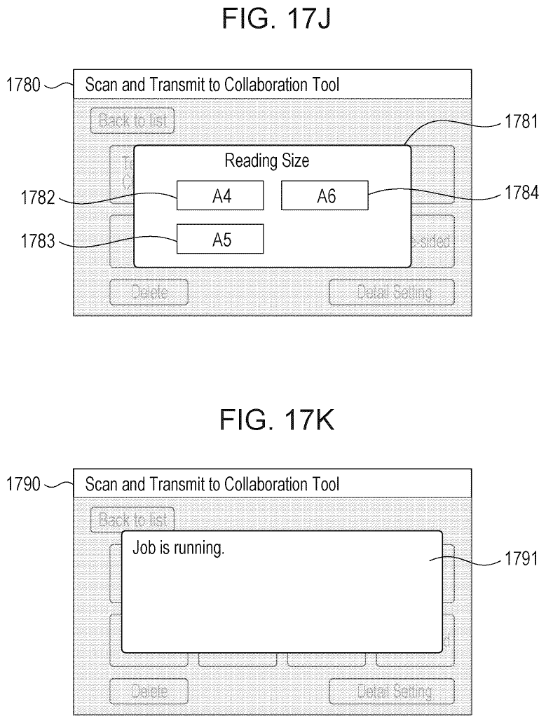

FIGS. 17A to 17K are diagrams illustrating transitions of screens displayed on the operation unit 419 of the MFP 120.

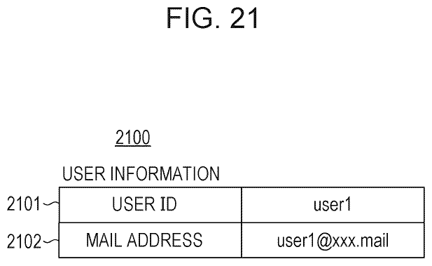

FIG. 21 illustrates exemplary data stored in the MFP 120.

The process of the flowchart in FIG. 8 will be described by using FIGS. 15, 17A to 17K, and 21.

The process of the flowchart starts in response to selection (hereinafter referred to as pressing) of a device registration button 1714 in a top menu screen 1710 in FIG. 17B. In addition, the process starts after completion of a user login process on a login screen 1700. A user's name and password are input to a user name input field 1701 and a password input field 1702, and a login button 1703 is pressed. Then, the login process is completed.

In S801, the device registration application 503 determines whether a device registration button 1716 has been pressed. If the determination result in S801 is YES, the process proceeds to S802. If the determination result is NO, the process returns to S801.

In S802, the device registration application 503 obtains a mail address which is address information of the login user. The MFP 120 has user information 2100, as illustrated in FIG. 21, for each user, and the user information 2100 is stored in advance in the HDD 414. Thus, a mail address 2102 associated with a user ID 2101 may be obtained.

In S803, the device registration application 503 obtains scan capability information of the MFP 120. The scan capability information refers to setting values allowed in various settings. The scan capability information obtained in this step is to be stored in scan capability information 1540 of the collaboration-tool information management server 130. The scan capability information 1540 will be described. A device ID 1541 is an identification (ID) unique to an MFP 120, and is information with which the MFP 120 may be identified uniquely. An allowable color setting 1542 indicates color settings settable in scanning, and has color information, such as color and gray. An allowable resolution setting 1543 indicates resolution settings settable in scanning, which are, for example, 600×600, 300× 300, and 100×100. An allowable sheet-size setting 1544 indicates sheet size settings settable in scanning, and has size information, such as A4, A3, B5, and B4. An allowable single/double-sided setting 1545 indicates single/double-sided settings settable in scanning, and has values of single sided, double sided (horizontal opening), and double sided (vertical opening). An allowable scaling setting 1547 indicates scaling settings settable in scanning, and has, for example, values of 50%, 100%, and 200%. An allowable file-format setting 1546 indicates file formats to which files may be converted after scanning, and has, for example, values of JPEG, PDF, and OOXML.

In S804, the device registration application 503 transmits, to the event processing application 702 of the collaboration-tool information management server 130, the mail address, which is obtained in S802, and the scan capability information, which is obtained in S803. Thus, user information 1530 and the scan capability information 1540, which are illustrated in FIG. 15, are generated on the collaboration-tool information management server 130, and information indicating the MFP 120 is registered in device-to-be-used information 1532. Multiple devices may be registered in the device-to-be-used information 1532. Thus, when S804 is performed by an MFP different from the MFP 120, the device ID 1541 of the MFP, which is a different device, is added to the device-to-be-used information 1532.

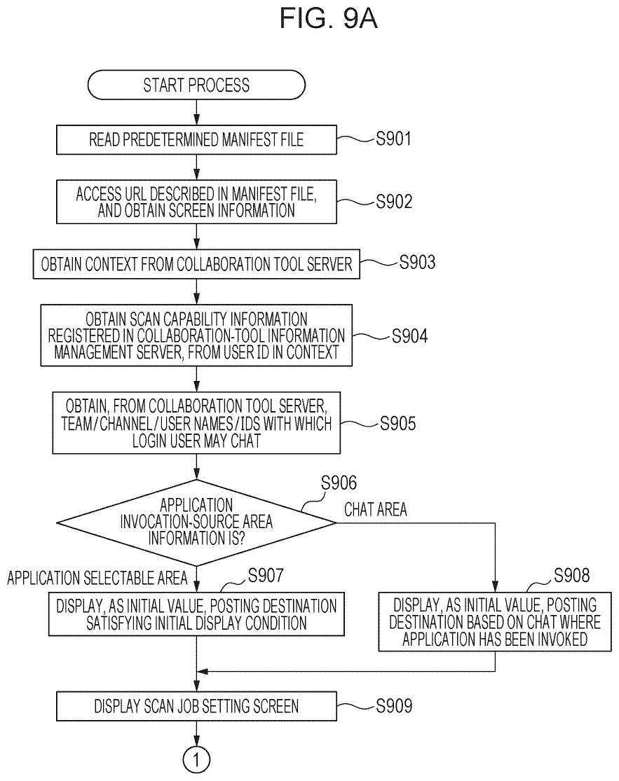

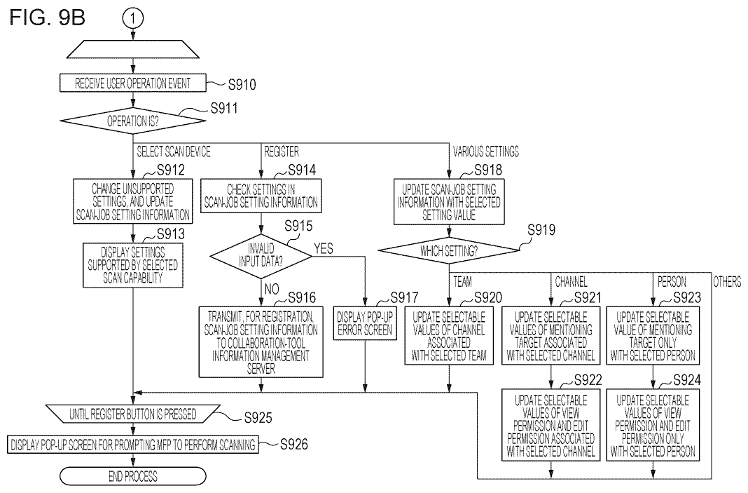

FIGS. 9A and 9B are a flowchart of an exemplary process performed so that, in the information processing apparatus 110, the collaboration tool application 301 uses screen information, which is obtained from the Web application 701, to register scan-job setting information to the collaboration-tool information management server 130.

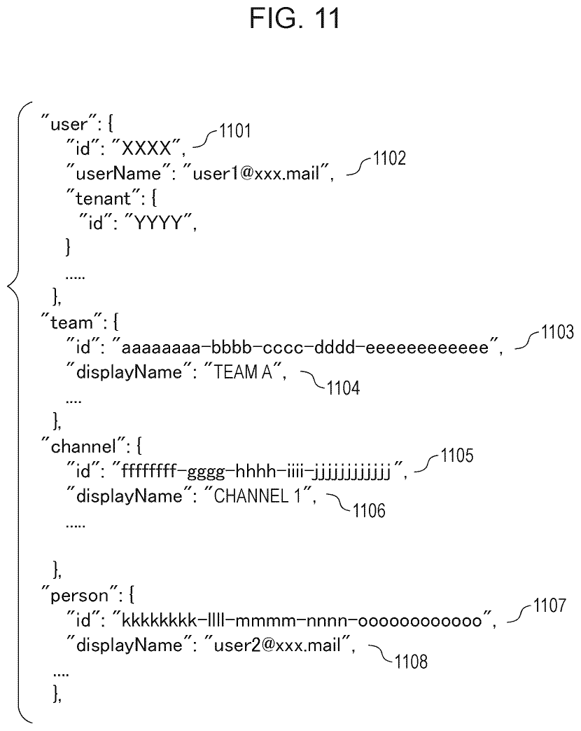

FIG. 11 is a diagram illustrating exemplary context information stored in the collaboration tool server 150.

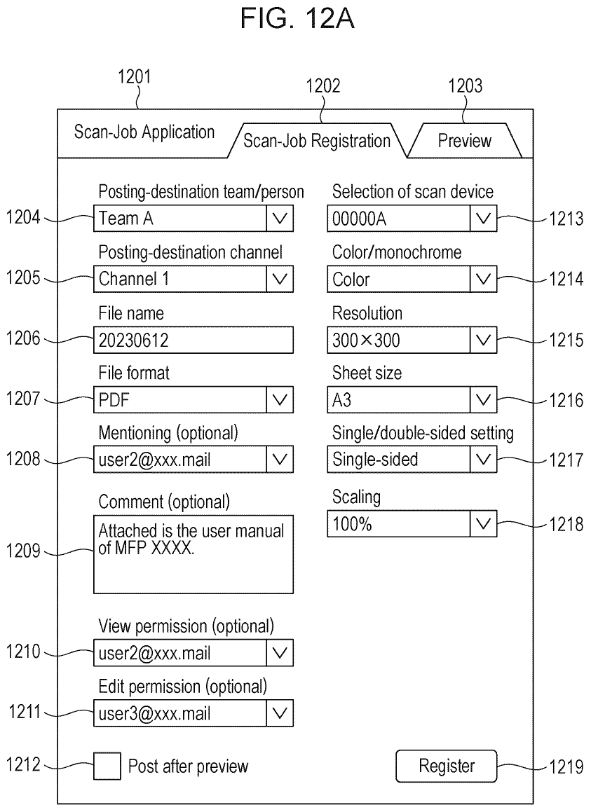

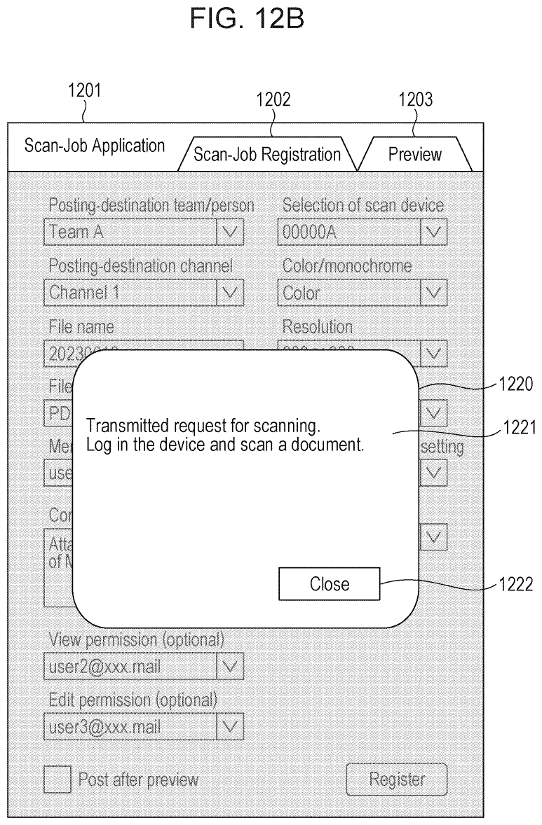

FIGS. 12A and 12B are diagrams illustrating an exemplary screen (scan-job application screen) 1201 which includes a scan job setting area and which is displayed on the display unit 206 of the information processing apparatus 110. In the scan-job application screen 1201, the scan job setting area (in FIG. 12A) may be displayed, and an area for prompting a process on the MFP (in FIG. 12B) may be displayed. Setting areas 1204 to 1208, 1210 to 1211, and 1213 to 1218, which are described below, each have a configuration in which a list of setting values, from which a setting value other than an initially displayed setting value may be selected by using a pull-down button provided on the right side of the setting area, is displayed.

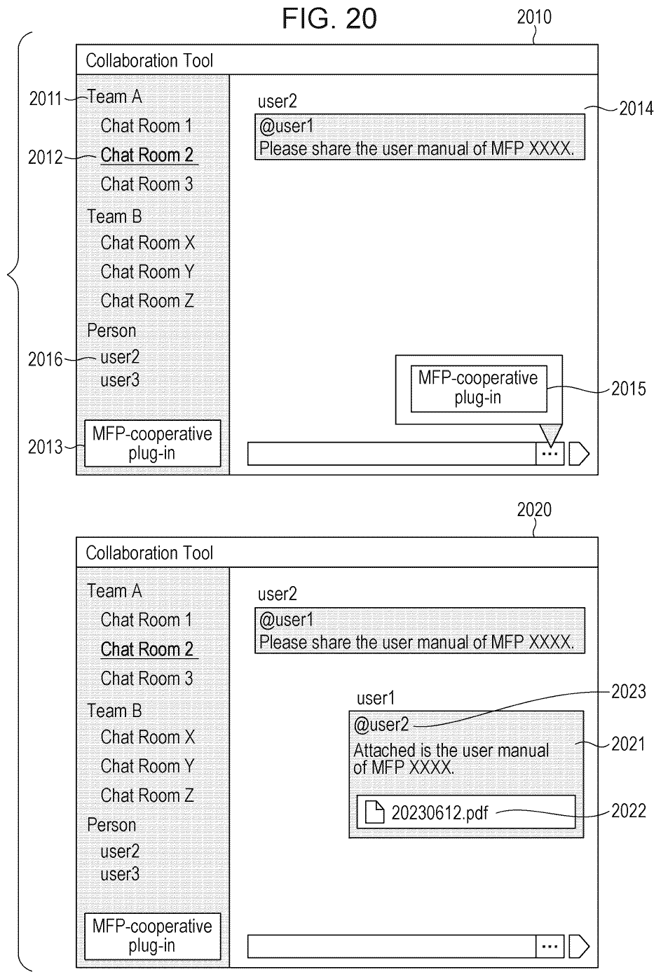

FIG. 20 is a diagram illustrating exemplary screens which are displayed on the display unit 206 of the information processing apparatus 110 and which include a chat room area (chat area) from which display of a list of setting values may be invoked.

The process of the flowchart in FIGS. 9A and 9B will be described by using FIGS. 11, 12A, 12B, and 20.

The process of the flowchart starts in response to the state in which, after a user uses the collaboration tool application 301 to perform a login process by using their user account, the user selects an area for starting the Web application 701. For example, the area for starting the Web application 701 is an MFP-cooperative plug-in application start button 2013. In addition, for example, the area for starting the Web application 701 is an MFP-cooperative plug-in application start button 2015 included in a predetermined area in a chat area 2014. The predetermined area in the chat area 2014 is, for example, is an area which is indicated by “ . . . ” in the chat area 2014 in FIG. 20 and selection of which causes a menu area, from which the Web application 701 is selectable, to be opened.

In S901, the collaboration tool application 301 reads, onto the RAM 203, a manifest file for a plug-in application stored in the HDD 204.

In S902, the collaboration tool application 301 accesses a uniform resource locator (URL) described in the manifest file. The URL destination is the collaboration-tool information management server 130. The Web application 701 transmits screen information, and the collaboration tool application 301 thus obtains the screen information.

In S903, the collaboration tool application 301 obtains pieces of context information from the collaboration tool server 150. The pieces of context information describe data illustrated in FIG. 11. The pieces of context information are a user ID 1101 and a user name 1102, a team ID 1103 and a team name 1104 of a plug-in invocation source, a channel ID 1105 and a channel name 1106 of the plug-in invocation source, and a person ID 1107 and a person name 1108 of the plug-in invocation source. These are values which change in accordance with how the plug-in application is invoked. For example, as illustrated in FIG. 20, when the plug-in application is invoked from the plug-in application start button 2015 in the state in which a chat room 2012 is selected, information about the chat screen 2014 is stored in the pieces of context information 1103 to 1106. Similarly, when the plug-in application is invoked from the plug-in application start button 2015 in the state in which a personal chat room 2016 is selected, information about the chat screen 2014 is stored in the pieces of context information 1107 and 1108. However, when the plug-in application is invoked from the plug-in application start button 2013, since the plug-in application is invoked from the outside of the chat screen, chat screen information fails to be detected, and values are not stored in the pieces of context information 1103 to 1108.

In S904, the collaboration tool application 301 obtains the user information 1530, which is registered in the collaboration-tool information management server 130, from the user ID 1101 in the context. Further, the collaboration tool application 301 obtains the scan capability information 1540, which is registered by a user in S804 in FIG. 8, from the device-in-use 1532 included in the user information 1530.

In S905, the collaboration tool application 301 obtains, from the collaboration tool server 150, team IDs, channel IDs, and user IDs, in or with which the login user may chat, and a list of the names of these.

In S906, the collaboration tool application 301 determines whether the invocation-source area information, which indicates the source, in the context, from which the application has been invoked, indicates a chat area or an area for invoking a Web application. The chat area refers to the cooperative plug-in application start-button area 2015; the area for invoking a Web application refers to the cooperative plug-in application start-button area 2013. Specifically, the collaboration tool application 301 checks the plug-in invocation-source team name 1104 and the plug-in invocation-source channel name 1106, or the plug-in invocation-source person ID 1108. When either one of these holds value, it is determined that the invocation source is the chat area. When these do not hold a value, it is determined that the invocation source is an area for invoking a Web application. In S906, if it is determined that the invocation source is a chat area, the process proceeds to S908. If it is determined that the invocation source is an area for invoking a Web application, the process proceeds to S907.

In S907, the collaboration tool application 301 displays, in the posting-destination team 1204 and the posting-destination channel 1205 illustrated in FIG. 12A described below, a posting destination which satisfies a preset initial display condition. Then, the process proceeds to S909. The condition (initial display condition) of the posting destination (initial display), which is displayed initially, is the posting destination (most-commonly-posted destination) to which scan data has been posted the most by using the user information of the user who has logged in. The most-commonly-posted destination refers to a team/channel obtained as follows: in S1315 and S1811 described below, the count of scan result files posted from the MFP 120 is measured for each team/channel of posting destination, and the team/channel having the most count is the most-commonly-posted destination. That is, when the Web application 701 is invoked from the area for invoking a Web application, as a posting destination to which scan data is to be posted, the posting destination based on usage information of the user account is displayed in the posting-destination team 1204 and the posting-destination channel 1205 as initial values. For example, when the most-commonly-posted destination of a login user is Team A/Channel 1, as illustrated in FIG. 12A, “Team A” and “Channel 1” are displayed in the posting-destination team 1204 and the posting-destination channel 1205, respectively. When the pull-down button (posting-destination list display button) on the right side of the posting-destination team 1204 is selected, information of teams/persons other than “Team A” which is initially displayed in the posting-destination team 1204 is displayed as a posting-destination list (selection area). For example, information of teams/persons displayed in the posting-destination list is displayed in the descending order of the counts of scan result files posted from the MFP 120. When information of a team/person is selected in the posting-destination list, the selected team/person information is displayed in the posting-destination team 1204 instead of “Team A” which is initially displayed.

In S908, the collaboration tool application 301 sets setting values, which are to be displayed as a posting destination, from the plug-in invocation source screen information described in the context. For example, the plug-in invocation-source team name 1104 is displayed in the posting-destination team 1204, and the plug-in invocation-source channel name 1106 is displayed in the posting-destination channel 1205. That is, when the Web application 701 is invoked from a chat area, as a posting destination to which scan data is to be posted, the posting destination based on the chat area, which is the invocation source, is displayed in the posting-destination team 1204 and the posting-destination channel 1205 as initial values. For example, when the plug-in is invoked from Team A/Channel 1, as illustrated in FIG. 12A, “Team A” and “Channel 1” are displayed in the posting-destination team 1204 and the posting-destination channel 1205, respectively. When the pull-down button on the right side of the posting-destination team 1204 is selected, information of teams/persons other than “Team A”, which is initially displayed in the posting-destination team 1204, is displayed as a posting-destination list. For example, information of teams/persons displayed in the posting-destination list is displayed in the descending order of the counts of scan result files posted from the MFP 120. When team/person information is selected in the posting-destination list, the selected information of a team/person is displayed in the posting-destination team 1204 instead of “Team A” which is initially displayed.

In S909, the collaboration tool application 301 displays the scan-job application screen 1201 of the Web application 701.

The scan-job application screen 1201 displays a scan job setting area 1202, in which setting values used in execution of scanning, a posting destination of the scanned file, the access permission of the file, and the like are set, and a preview display area 1203.

In the scan job setting area 1202, user interfaces, such as pull-down menus, a text box, a text area, a checkbox, and a button, are present. The setting values from the posting-destination team/person 1204 to the scaling 1218 are stored in the RAM 203 as the scan-job setting information. The scan-job setting information is data having the same structure as that of the scan-job setting information 1500 in FIG. 15. The posting-destination team/person 1204 displays a list of team names and user names, which are obtained in S905 and in or with which the login user may chat, through the user's pull-down selection.

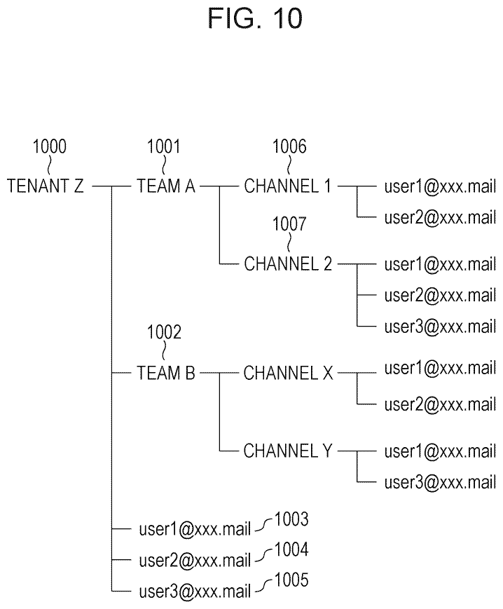

FIG. 10 is used to describe the relationship between tenant, team channel, and user. Tenant Z 1000 includes Team A (1001), Team B (1002), user 1 (1003), user 2 (1004), and user 3 (1005). Team A (1001) includes Channel 1 (1006) and Channel 2 (1007), each of which has a chat room. Channel 1 (1006) includes user 1 (1003) and user 2 (1004) who participate in the chat room. For each channel, users who participate in the channel may be managed. For example, user 1 (1003) and user 2 (1004) participate in Channel 1 (1006), while user 1 (1003), user 2 (1004), and user 3 (1005) participate in Channel 2 (1007). The options of the pull-down menu of the posting-destination team/person 1204 are teams and users included in Tenant Z 1000, and are teams/persons 1001 to 1005. The posting-destination channel 1205 displays a list of selectable channels through a user's pull-down selection. A list of selectable channels will be described below. The file name 1206 receives a user's input of characters in the text box to determine the name of a file generated in scanning. The file format 1207 is Portable Document Format (PDF), Office Open XML (OOXML), or Joint Photographic Experts Group (JPEG). However, the file format handled in the present disclosure is not limited to the formats described above. The mentioning setting 1208 is a pull-down menu for specifying which user is to be notified, which is used in a function, “mentioning”, of notifying a specified user (user information). Users, who may be specified in the pull-down menu, are, for example, in FIG. 10, user 1, user 2, and user 3 belonging to Tenant Z 1000. The comment 1209 is a message displayed when a scan result is posted to a chat room. The view permission 1210 and the edit permission 1211 are pull-down menus for specifying which permission, view permission or edit permission, of a scan result file posted to a chat room is granted to which user who participates in the chat room. Users, who may be specified in the pull-down menu, are, for example, in FIG. 10, user 1, user 2, and user 3 belonging to Tenant Z 1000, or a setting, “the same as the mentioning target”, is allowed. The posting-after-preview checkbox 1212 is a checkbox for setting whether scan data is to be confirmed in the preview area 1203 before the scan result file is posted to a chat room. The scan device selection 1213 displays a list of devices, which are registered in FIG. 8, through a user's pull-down selection. The color setting 1214 to the scaling 1218 are scan setting items used when the MFP 120 performs scanning. The register 1219 is a button for registering a job through pressing after completion of job setting. Steps S910 to S923, which are subsequent steps, are repeatedly performed until the condition in S925 is satisfied.

Back to FIG. 9B, the flowchart will be described.

In S910, the collaboration tool application 301 receives a user operation event. A user operation event occurs by a user operating a user interface in the scan job setting area 1202 and completing the operation. Specifically, in the case of a pull-down menu, a user operation event occurs when any of options, which are displayed through pressing the pull-down button, is selected. In the case of a text box and a text area, a user operation event occurs when characters are input and the cursor then goes out of the input field. In the case of a checkbox, a user operation event occurs when the checkbox is checked or unchecked. In the case of a button, a user operation event occurs when the button is pressed.

In S911, the collaboration tool application 301 determines which item has been operated in S910. If it is determined that the scan device selection 1213 has been operated, the collaboration tool application 301 proceeds to S912. If it is determined that the register 1219 has been operated, the collaboration tool application 301 proceeds to S914. If it is determined that an item other than the two items described above has been operated, the collaboration tool application 301 proceeds to S918.

In S912, the collaboration tool application 301 obtains, from the collaboration-tool information management server 130, the scan capability information of the device selected in the scan device selection 1213, and stores the scan capability information in the RAM 203. The scan capability information described above is data having the same structure as that of the scan capability information 1540 in FIG. 15. The collaboration tool application 301 compares the obtained scan capability information with the setting values of the color setting 1214 to the scaling 1218 of the scan-job setting information on the RAM 203. When various settings included in the scan-job setting information are not included in the setting values of the scan capability information, the setting values of such setting items are changed to defaults or nulls, and the scan-job setting information is updated. Default values are obtained from the scan capability information (not illustrated).

The reason why nulls are used is, for example, that, even when a device used in scanning does not support scaling setting, scanning is allowed to be performed.

In S913, the collaboration tool application 301 filters the options, which are to be displayed when pull-down buttons of the color setting 1214 to the scaling 1218 are selected, to setting values included in the scan capability information obtained in S912. The collaboration tool application 301 updates the display of the color setting 1214 to the scaling 1218. When no device is selected in the scan device selection 1213, the options of the color setting 1214 to the scaling 1218 are all setting values which are settable.

For example, when a device, which supports the sheet sizes of A4, A5, and A6, is selected in the scan device selection 1213, the sheet size options are A3, A4, A5, A6, and B4 before the selection, and are A4, A5, and A6 after the selection. When the color setting 1214 to the scaling 1218 have been already selected, the values of the color setting 1214 to the scaling 1218 are deleted, and blanks are displayed in the color setting 1214 to the scaling 1218.

In S914, the collaboration tool application 301 checks whether the scan-job setting information on the RAM 203 has invalid setting values. Specifically, the posting-destination team/person 1204 and the posting-destination channel having no values cause invalid values (errors) because a chat room to which a scan result image is to be posted is unknown.

In S915, the collaboration tool application 301 determines whether the result in S914 indicates invalid values. If the determination result in S915 is YES, the process proceeds to S917. If the determination result in S915 is NO, the process proceeds to S916.

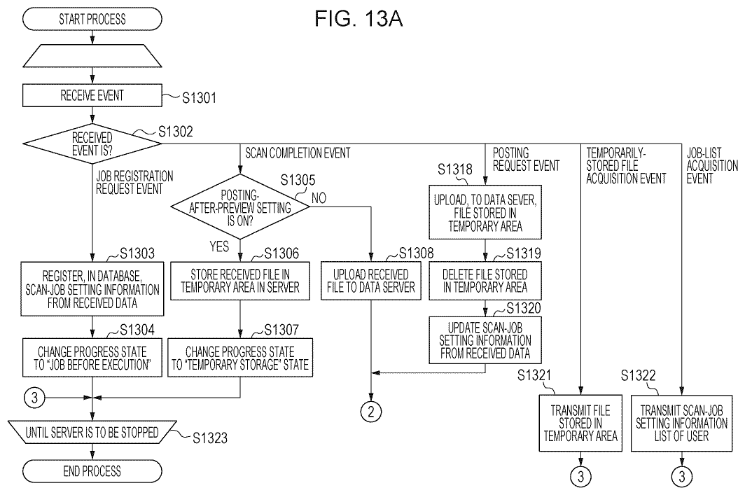

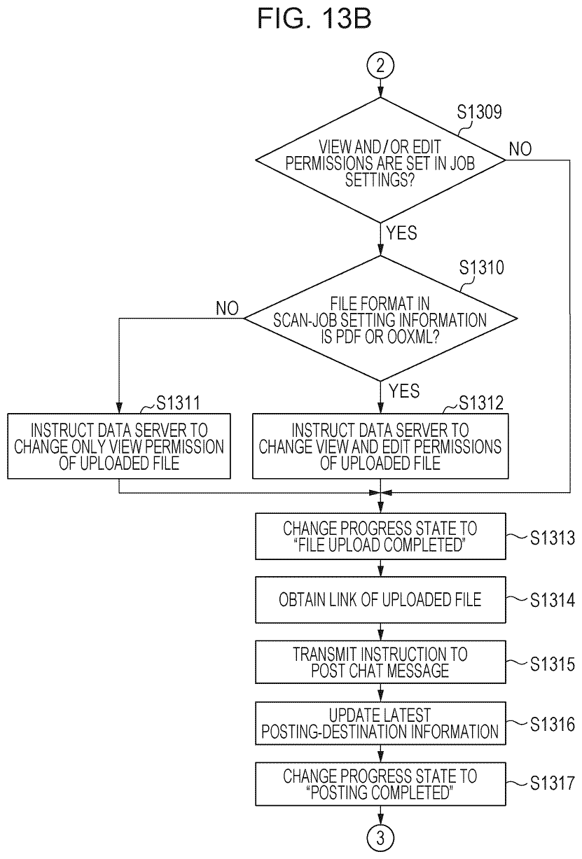

In S916, the collaboration tool application 301 transmits, to the collaboration-tool information management server 130, the scan-job setting information on the RAM 203, and requests registration of the job. The job registration process by the collaboration-tool information management server 130 will be described below in the description about FIGS. 13A and 13B.

In S917, the collaboration tool application 301 displays a pop-up error screen (not illustrated) indicating that setting values of the scan-job setting information are invalid.

In S918, the collaboration tool application 301 updates the scan-job setting information on the RAM 203 by using the selected setting value.

In S919, the collaboration tool application 301 determines what is the setting operation determined in S911. If a team has been set in the posting-destination team/person 1204, the process proceeds to S920. If it is determined that a person has been set in the posting-destination team/person 1204, the process proceeds to S923. If it is determined that a posting-destination channel has been set, the process proceeds to S921. If it is determined that an item other than those described above has been set, the process proceeds to S925.

In S920, the collaboration tool application 301 filters the options, which are to be displayed when a pull-down button of the posting-destination channel 1205 is selected, to those associated with the selected team, and updates the display of the posting-destination channel 1205. Specifically, when Team A 1001 in FIG. 10 is selected in the posting-destination team/person 1204, the options, which are to be displayed when the pull-down button of the posting-destination channel 1205 is selected, are only Channel 1 and Channel 2, and Channel X and Channel Y are not included in the options. When the posting-destination channel 1205 has been already selected, the value of the posting-destination channel of the scan-job setting information is deleted, and a blank is displayed in the posting-destination channel 1205.

In S921, the collaboration tool application 301 filters the options, which are to be displayed when the pull-down button of the mentioning 1208 is selected, to those associated with the selected channel, and updates the display of the mentioning 1208. Specifically, when Channel 1 in FIG. 10 is selected in the posting-destination channel 1205, the options, which are to be displayed when the pull-down button of the mentioning 1208 is selected, are user 1 and user 2, and user 3 is not included in the options. When the mentioning 1208 has been already selected, the value of the mentioning target of the scan-job setting information is deleted, and a blank is displayed in the mentioning 1208.

In S922, the collaboration tool application 301 filters the options, which are to be displayed in response to selection of the pull-down buttons of the view permission 1210 and the edit permission 1211 which indicate access permission settings for setting user information accessible to the scan data, only to those associated with the selected channel. At least when at least one of the pull-down buttons of the view permission 1210 and the edit permission 1211 is selected, the collaboration tool application 301 updates, for display, the options of each permission. Specifically, when Channel 1 in FIG. 10 is selected in the posting-destination channel 1205, the options, which are to be displayed when the pull-down buttons of the view permission 1210 and the edit permission 1211 are selected, are user 1, user 2, and “the same as mentioning target”, and user 3 is not included in the options. When “the same as mentioning target” is selected in the options for the pull-down button of the view permission 1210, view permission is granted to the same user information as that set in the mentioning 1208. The same is true for the edit permission 1211. When the view permission 1210 and the edit permission 1211 have been already selected before update of the display, the values selected and displayed in the view permission 1210 and the edit permission 1211 of the scan-job setting information are deleted, and blanks are displayed in the view permission 1210 and the edit permission 1211. Depending on the file format selected in the file format 1207, whether reception of setting of user information, to which edit permission is granted, is allowed may be changed. Specifically, when the file format selected in the file format 1207 is PDF format or OOXML format, reception of setting of user information, to which edit permission is granted, may be allowed. When the file format selected in the file format 1207 is a format other than PDF format and OOXML format, reception of setting of user information, to which edit permission is granted, may not be allowed. For example, when the file format selected in the file format 1207 is a format other than PDF format and OOXML format, the edit permission 1211 may be displayed in gray out.

In S923, the collaboration tool application 301 filters the options, which are to be displayed when the pull-down button of the mentioning 1208 is selected, to those for the selected person, and updates display of the mentioning 1208. Specifically, when user 1 in FIG. 10 is selected in the posting-destination team/person 1204, the options, which are to be displayed when the pull-down button of the mentioning 1208 is selected, are only user 1, and user 2 and user 3 are not included in the options. When the mentioning 1208 has been already selected, the value of the mentioning target of the scan-job setting information is deleted, and a blank is displayed in the mentioning 1208.

In S924, the collaboration tool application 301 filters the options, which are to be displayed when the pull-down buttons of the view permission 1210 and the edit permission 1211 are selected, to those for the selected person. The collaboration tool application 301 updates display of the view permission 1210 and the edit permission 1211. Specifically, when user 1 in FIG. 10 is selected in the posting-destination team/person 1204, the options, which are to be displayed when the pull-down buttons of the view permission 1210 and the edit permission 1211 are selected, are user 1, and user 2 and user 3 are not included. When the view permission 1210 and the edit permission 1211 have been already selected, the values of the view permission 1210 and the edit permission 1211 of the scan-job setting information are deleted, and blanks are displayed in the view permission 1210 and the edit permission 1211.

In S925, if it is determined that the operation is pressing of the registration button, the collaboration tool application 301 proceeds to S926. If it is determined that the operation is not pressing of the registration button, the collaboration tool application 301 proceeds to S910.

In S926, the collaboration tool application 301 displays a screen (pop-up screen) 1220 including a pop-up notification in FIG. 12B. A message 1221 is a message for prompting the MFP 120 to perform a login process and perform scanning (execution of a scan execution instruction). When a close button 1222 is pressed, the pop-up screen is closed. FIGS. 13A and 13B are a flowchart of an example of the event processing application 702 of the collaboration-tool information management server 130 receiving events from the information processing apparatus 110 and the MFP 120 to perform various processes.

FIG. 15 is a diagram illustrating exemplary data stored in the collaboration-tool information management server 130.

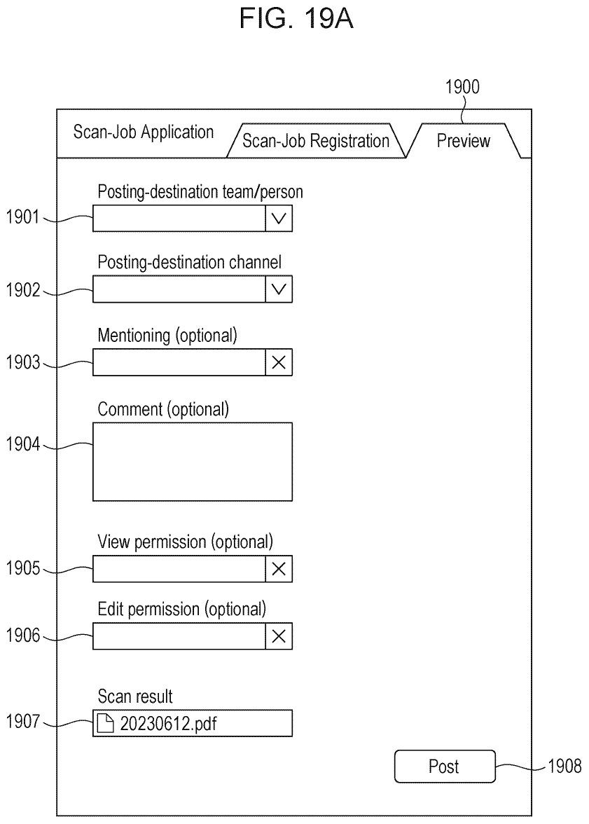

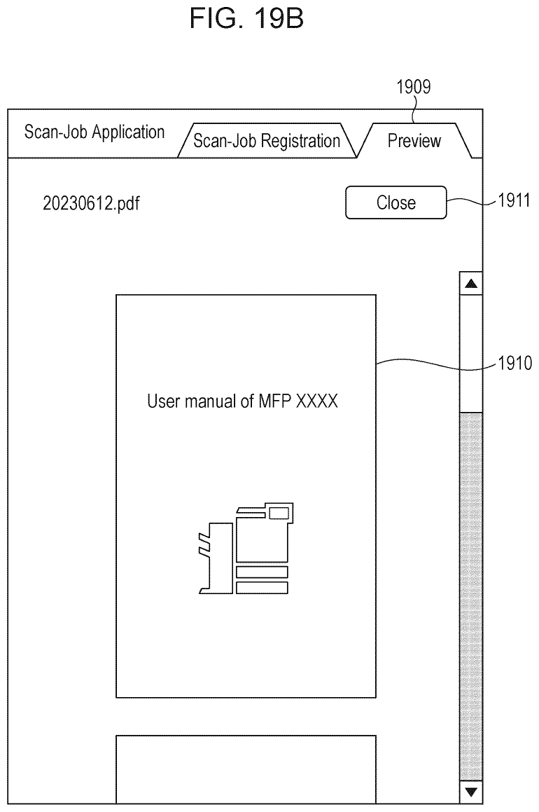

FIGS. 19A and 19B are diagrams illustrating an exemplary preview screen displayed on the display unit 206 of the information processing apparatus 110.

The flowchart in FIGS. 13A and 13B will be described by using FIGS. 15, 19A, and 19B.

The flowchart starts by the CPU 601 reading the event processing application 702 stored in the HDD 604 after the collaboration-tool information management server 130 starts. The event processing application 702 repeatedly performs S1301 to S1323 to process various received events, and thus operates as a server.

In S1301, the event processing application 702 receives an event from the information processing apparatus 110 or the MFP 120.

In S1302, the event processing application 702 determines which event has been received in S1301. If it is determined that the received event is a job registration request event from the information processing apparatus 110, the process proceeds to S1303. If it is determined that the received event is a scan completion event from the MFP 120, the process proceeds to S1305. If it is determined that the received event is a posting request event from the information processing apparatus 110, the process proceeds to S1318. If it is determined that the received event is a temporarily-stored file acquisition event from the information processing apparatus 110, the process proceeds to S1321. If it is determined that the received event is a job-list acquisition event from the MFP 120, the process proceeds to S1322.

In S1303, the event processing application 702 stores (registers), in the database 703, the scan-job setting information 1500, illustrated in FIG. 15, from the received data. A user ID 1501 is used to uniquely identify a user who uses the system. In the present embodiment, a mail address is used. A job ID 1502 is information for uniquely identifying the scan-job setting information registered in the collaboration-tool information management server 130. In the present embodiment, data obtained through incrementing from “000001” every time scan-job setting information is registered is used. A posting-destination team name 1503 is the name of a team to which a scan result file (scan data) is posted, and is the team name displayed in 2011 in a collaboration-tool application screen 2010. A posting-destination team ID 1504 is an ID for uniquely identifying the team of the posting-destination team name 1503, and is used in submitting a posting instruction to the collaboration tool server 150. A posting-destination channel name 1505 is the name of a channel to which a scan result file is posted, and is a channel name displayed in 2012 in the collaboration-tool application screen 2010. The posting-destination channel ID 1506 is an ID for uniquely identifying a channel of the posting-destination channel name 1505, and is used in submitting a posting instruction to the collaboration tool server 150. The posting-destination user name 1507 is the name of a user who posts a scan result file, and is a user name displayed in 2016 in the collaboration-tool application screen 2010. The posting-destination user ID 1508 is an ID for uniquely identifying a chat of the posting-destination user name 1507, and is used in submitting a posting instruction to the collaboration tool server 150. In the present embodiment, posting to a channel and posting to a user are not allowed to be specified at the same time. When the pieces of posting-destination team/posting-destination channel information 1503 to 1506 are specified, the posting-destination user name and the posting-destination user ID are set to null. In contrast, when the pieces of posting-destination user information 1507 and 1508 are specified, the pieces of posting-destination team/posting-destination channel information 1503 to 1506 are set to null. A main text 1510 is a text which is to be displayed in 2021 in an after-posting-message screen 2020 in posting. The file name 1511 is the file name of a scan result, and is displayed in 2022 in the after-posting-message screen 2020 in posting. A mentioning target name 1512 is the name of a user to whom the mentioning is set in posting, and is displayed in 2023 in the after-posting-message screen 2020 in posting. A mentioning target name ID 1513 is an ID for uniquely identifying a mentioning target in posting, and is used in submitting a posting instruction to the collaboration tool. The progress state 1514 indicates the state of the job of the scan-job setting information. As the progress state, “job before execution”, “temporary storage”, “file upload completed”, “posting completed” are present. An execution finish flag 1515 is a flag indicating whether the job of the scan-job setting information has been executed once. “True” indicates that the job has been completed; “false” indicates that the job has not been performed. After that, 1516 to 1521 indicate various settings in execution of a scan job in the MFP 120. A view permission setting 1522 indicates the user ID of a user who have view permission of a posted scan result file. An edit permission setting 1523 indicates the user ID of a user who has edit permission of a posted scan result file. A scan result file link is a link URL of storage of a scan result file in the data server 140.

In S1304, the event processing application 702 changes (updates) the progress state of the scan-job setting information, which has been stored in the database 703 in S1303, to “job before execution”, and proceeds to S1323.

In S1323, the event processing application 702 determines whether a stop instruction to stop the server has been received. If it is determined that a stop instruction has been received, the process of the flowchart ends. If it is determined that a stop instruction has not been received, the process proceeds to S1301.

In S1305, the event processing application 702 writes, from the database 703 to the RAM 603, scan-job setting information whose job ID matches that included in the scan completion event. The event processing application 702 determines whether the setting of a posting-after-preview setting 1509 of the scan-job setting information written in the RAM 603 is ON. If the determination result in S1305 is YES, the process proceeds to S1306. If the determination result is NO, the process proceeds to S1308.

In S1306, the event processing application 702 stores the scan result file, which is included in the scan completion event, in the HDD 604 as a temporary file, and proceeds to S1307.

In S1307, the event processing application 702 updates, for storage, the progress state 1514 of the scan-job setting information in the database 703, whose job ID matches that included in the scan completion event, to the “temporary storage” state, and proceeds to S1323.

In S1308, the event processing application 702 uploads, to the data server 140, the scan result file included in the scan completion event. The event processing application 702 stores, in the scan result file link 1524 in the database 703, the upload destination link returned as a response of the upload, and proceeds to S1309.

In S1309, the event processing application 702 determines whether user IDs are set to either one or both of the view permission setting 1522 and the edit permission setting 1523 of the scan-job setting information written in the RAM 603 in S1305. If it is determined that user IDs are set, the process proceeds to S1310. If it is determined that user IDs are not set, the process proceeds to S1313.

In S1310, the event processing application 702 determines whether or not the file format 1520 of the scan-job setting information, which is written in the RAM 603 in S1305, is PDF or OOXML. If the determination result is YES, the process proceeds to S1312. If the determination result is NO, the process proceeds to S1311.

In S1311, the event processing application 702 transmits, to the data server 140, a specific instruction that, when the view permission setting 1522 of the scan-job setting information stores user IDs, the setting of the view permission of the uploaded file be changed so that the user IDs are allowed to view the file. The event processing application 702 transmits a specific instruction that, when the edit permission setting 1523 of the scan-job setting information stores user IDs, the setting of the view permission of the uploaded file be changed so that the user IDs are allowed to view the file.

In S1312, the event processing application 702 transmits, to the data server 140, a predetermined instruction that, when the view permission setting 1522 of the scan-job setting information stores user IDs, the setting of the view permission of the uploaded file be changed so that the user IDs are allowed to view the file. The event processing application 702 transmits an instruction that, when the edit permission setting 1523 of the scan-job setting information stores user IDs, the setting of the edit permission of the uploaded file be changed so that the user IDs are allowed to edit the file.

In S1313, the event processing application 702 refers to the scan-job setting information in the database 703, whose job ID matches that included in the scan-job setting information on the RAM 603. The event processing application 702 updates, for storage, the progress state 1514 of the scan-job setting information in the database 703 with “file upload completed”, and proceeds to S1314.

In S1314, the event processing application 702 obtains a file link indicating the access destination to the file uploaded in S1308, and proceeds to S1315.

In S1315, the event processing application 702 instructs the collaboration tool server 150 to post a chat message. The chat message to be posted is created with the posting destination and the posting description determined by the scan-job setting information in the database 703, and includes a file link indicating the access destination to the file. Thus, as illustrated in the after-posting-message screen 2020 in FIG. 20, the scan result file is posted to the user-desired posting destination.

In S1317, the event processing application 702 updates, for storage, the progress state 1514 of the scan-job setting information in the database 703 with “posting completed”, and proceeds to S1323.

In S1318, the event processing application 702 uploads, to the data server 140, the scan result file stored as a temporary file in the HDD 604 in S1306, and proceeds to S1319.

In S1319, the event processing application 702 deletes the scan result file stored as a temporary file in the HDD 604 in S1306, and proceeds to S1320.

In S1320, the event processing application 702 updates the scan-job setting information in the database 703 on the basis of the received data received in S1301, and proceeds to S1309. The scan-job setting information is updated to reflect the data, which has been set by a user in 1901 to 1906 in FIG. 19A, on a chat message that is to be posted. The posting-destination team setting 1901 is an item for setting a posting-destination team or a person as a posting destination. The data which is set in the posting-destination team 1204 is displayed, and the displayed data may be changed by a user. The posting-destination channel setting 1902 is an item for setting a posting-destination channel. The data which is set in the posting-destination channel 1205 is displayed, and the displayed data may be changed by a user. The mentioning target setting 1903 is an item for setting a mentioning target used in posting. The data which is set in the mentioning target 1208 is displayed, and the displayed data may be changed by a user. The comment setting 1904 is an item for setting a comment used in posting. The data which is set in the comment 1209 is displayed, and the displayed data may be changed by a user. The view permission setting 1905 is an item for setting the user IDs of users who have view permission of the scan result file that is to be posted. The data which is set in the view permission setting 1210 is displayed, and the displayed data may be changed by a user. The edit permission setting 1906 is an item for setting the user IDs of users who have edit permission of the scan result file that is to be posted. The data which is set in the edit permission setting 1211 is displayed, and the displayed data may be changed by a user. When a scan result file button 1907 is pressed, a preview screen 1909 is displayed. The preview display area (hereinafter, preview screen) 1909 includes a preview 1910 of the scan result file. Pressing a close button 1911 may cause a return to the previous page (for example, a job detail screen 1900). When a post button 1908 is pressed, the set items are reflected, and a request to post a chat message is transmitted to the collaboration-tool information management server 130.

In S1321, the event processing application 702 transmits, to the connection source (information processing apparatus 110), the scan result file stored as a temporary file in the HDD 604 in S1306, and proceeds to S1323.

In S1322, the event processing application 702 transmits, to the connection source (information processing apparatus 110), the scan-job setting information 1500, in the database 703, which includes the user ID included in the received data received in S1301, and proceeds to S1323.

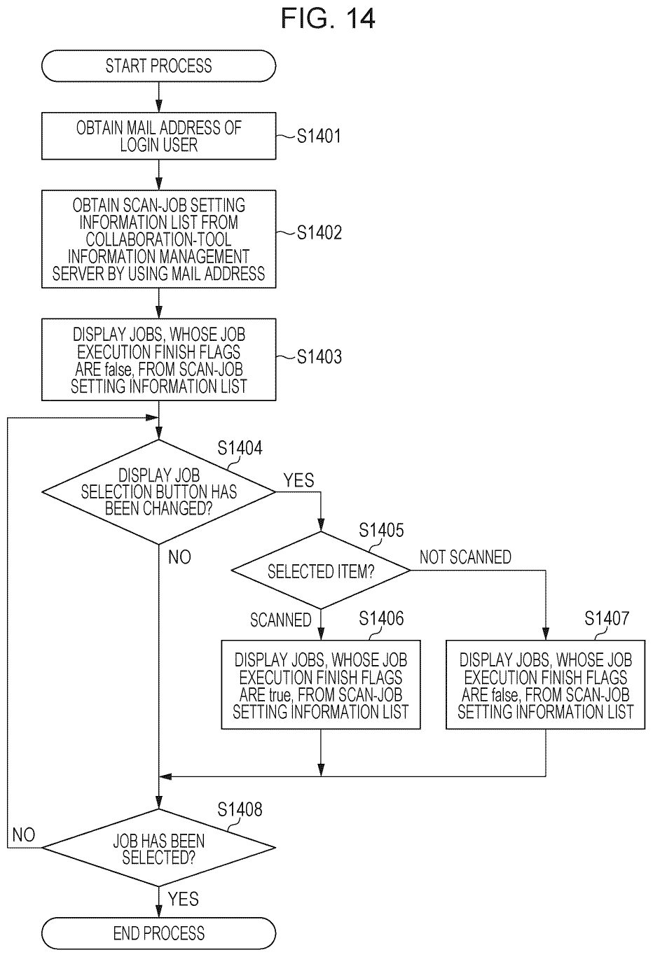

FIG. 14 is a flowchart of a process performed so that the collaboration-tool cooperative application 504 of the MFP 120 establishes a connection with the collaboration-tool information management server 130 to display the waiting-for-scan job list screen 1720 and the scan-completed job list screen 1730 in FIGS. 17D and 17E. The flowchart starts in response to pressing a “scan and transmit to collaboration tool” button 1712 after a login to the MFP 120.

In S1401, the collaboration-tool cooperative application 504 obtains a mail address of the login user. The mail address is the same as that obtained in S802 in FIG. 8, and is associated with a user ID 1531 of the collaboration-tool information management server 130.

In S1402, the collaboration-tool cooperative application 504 obtains a scan-job setting information list from the collaboration-tool information management server 130 by using the mail address obtained in S1401.

In S1403, the collaboration-tool cooperative application 504 displays the waiting-for-scan job list screen 1720. The jobs, which are included in the scan-job setting information list obtained in S1402 and whose job execution finish flags 1515 are not true, are displayed on a job list display unit 1722. In S1404, the collaboration-tool cooperative application 504 determines whether a display job selection button 1721 has been changed. If the display job selection button 1721 has not been changed, the process proceeds to S1408. If the display job selection button 1721 has been changed, the process proceeds to S1405.

In S1405, the collaboration-tool cooperative application 504 determines whether the changed selection item is “scanned”. If the item is “scanned”, the process proceeds to S1406. If the item is “not scanned”, the process proceeds to S1407.

In S1406, the collaboration-tool cooperative application 504 displays the scan-completed job list screen 1730. The jobs, which are included in the scan-job setting information list obtained in S1402 and whose job execution finish flags 1515 are true, are displayed on a job list display unit 1732. In S1407, like S1403, the collaboration-tool cooperative application 504 displays the jobs, which are included in the scan-job setting information list and whose job execution finish flags 1515 are not true, in the job list display unit 1722.

In S1408, the collaboration-tool cooperative application 504 determines whether a job displayed on the operation unit 419 has been selected. If a job has not been selected, the process returns to S1404. If a job has been selected, the collaboration-tool cooperative application 504 stores the scan-job setting information of the selected job in the RAM 413, and displays the scan setting screen 1740.

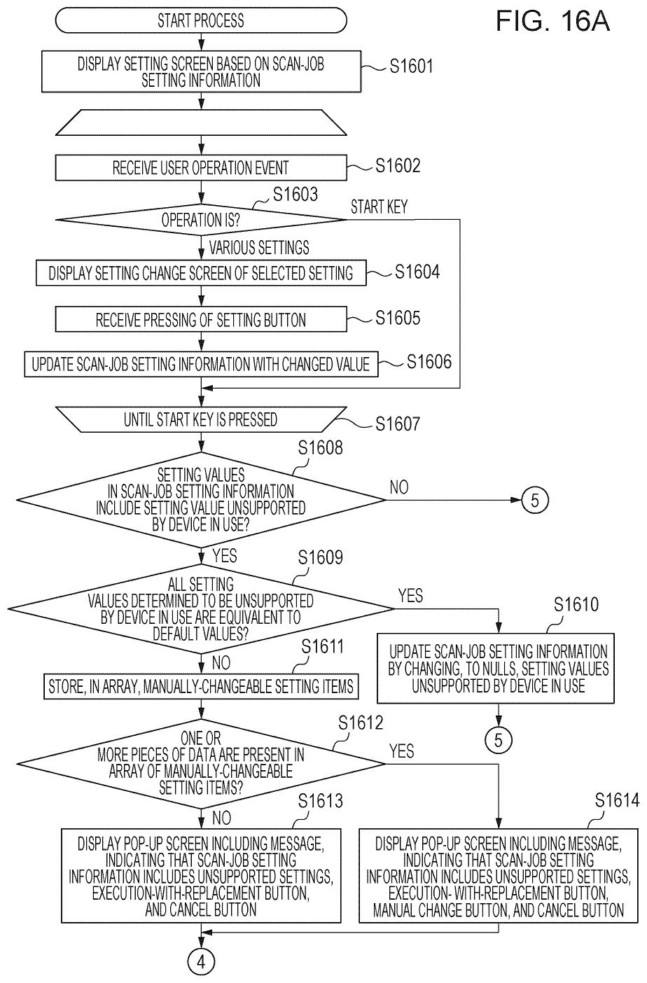

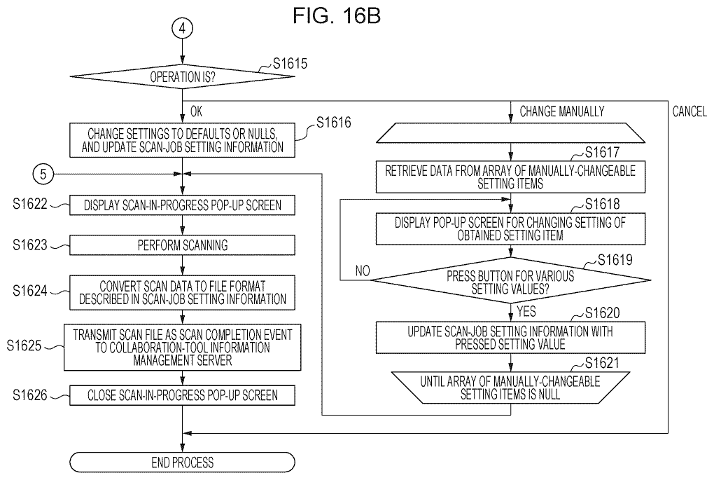

FIGS. 16A and 16B are a flowchart of a process performed so that the collaboration-tool cooperative application 504 of the MFP 120 establishes a connection with the collaboration-tool information management server 130; a scan setting screen 1740 in FIG. 17F is displayed; and scanning is performed. The trigger for starting the flowchart is selection of a job displayed on the job list display units 1722 and 1732.

In S1601, the collaboration-tool cooperative application 504 displays the scan setting screen 1740 in FIG. 17F on the basis of the scan-job setting information stored in the RAM 413 in S1408. The scan-job setting information described above is data having the same structure as that of the scan-job setting information 1500 in FIG. 15. The scan setting screen 1740 displays a back-to-list button 1741, a transmission destination 1742, a color setting button 1743, an image quality setting button 1744, a sheet size button 1745, a double-sided setting button 1746, a detail setting button 1747, and a delete button 1748. The back-to-list button 1741 makes a screen transition to the waiting-for-scan job list screen 1720 through pressing. The transmission destination 1742 displays the posting-destination channel name and the posting-destination team name of the scan-job setting information. The color setting button 1743, the image quality setting button 1744, the sheet size button 1745, and the double-sided setting button 1746 display, on the respective buttons, the setting values of the setting items from the scan-job setting information. For example, pressing the color setting button 1743 causes a color setting screen 1770 to be displayed. Pressing the detail setting 1747 causes setting items, which are not displayed in the scan setting screen 1740, to be displayed in a screen (not illustrated). Pressing the delete button 1748 causes transmission, to the collaboration-tool information management server 130, of an instruction to delete data related to the job ID 1502 of the scan-job setting information. Thus, a process (not illustrated) of deleting the scan-job setting information, on the collaboration-tool information management server 130, of the job ID is performed. After that, S1602 to S1606 are repeatedly performed until the condition in S1607 is satisfied.

In S1602, the collaboration-tool cooperative application 504 receives a user operation event.

In S1603, the collaboration-tool cooperative application 504 determines which button has been pressed in S1602. If the pressed button is one for various settings related to scanning, such as the color setting button 1743, the process proceeds to S1604. If the pressed button is a start key, the process proceeds to S1607. The process, which is performed in the case in which the pressed button is the detail setting button 1747 or the delete button 1748, is not important in the present disclosure, and will not be described.

In S1604, the collaboration-tool cooperative application 504 displays a setting change screen for changing the setting. For example, pressing the color setting button 1743 causes the collaboration-tool cooperative application 504 to display a color setting pop-up screen 1771 in the color setting screen 1770. The color setting pop-up screen 1771 displays setting buttons, such as an automatic color button 1772, a color button 1773, and a monochrome button 1774.

In S1605, the collaboration-tool cooperative application 504 receives pressing of a displayed setting button.

In S1606, the collaboration-tool cooperative application 504 updates the scan-job setting information on the RAM 413 with the setting value of the pressed setting button.

In S1607, the collaboration-tool cooperative application 504 determines whether the start key has been pressed. If it is determined that the start key has been pressed, the process proceeds to S1608.

If it is determined that the start key has not been pressed, the process proceeds to S1602.

In S1608, the collaboration-tool cooperative application 504 determines whether the setting values of the settings included in the scan-job setting information include a setting value which is not supported by the MFP 120. For example, the setting values of the sheet size, which are supported by the MFP 120, are A4, A5, and A6, while the setting value of the sheet size of the scan-job setting information is A3. In this case, since the MFP 120 does not support A3, the process proceeds to S1609. For example, the MFP 120, which does not support scaling, performs scanning with a scaling of 100%. However, when the setting of scaling is set to 100% in the scan-job setting information, the MFP 120, which does not support scaling, determines that there is an unsupported setting value, and the process proceeds to S1609. When the MFP 120 supports all the setting values of the scan-job setting information, the process proceeds to S1622.

In S1609, the collaboration-tool cooperative application 504 determines whether all the setting values determined not to be supported by the MFP 120 in S1608 are equivalent to the default values of the settings. As in the example of scaling described above, in the MFP 120 which does not support scaling, when the setting of scaling of the scan-job setting information is 100%, it is determined that this is equivalent to the default value. If it is determined that all the setting values, which are not supported by the MFP 120, are equivalent to the default values, the process proceeds to S1610. If it is determined that not all the setting values are equivalent to the default values, the process proceeds to S1611.

In S1610, the collaboration-tool cooperative application 504 updates the scan-job setting information by changing the setting values, which are not supported by the MFP 120, to nulls. As described above, when scaling is set, it is determined that an unsupported setting value is set. Thus, scanning fails to be performed. Therefore, to perform scanning, such settings of the scan-job setting information are updated with nulls.

In S1611, the collaboration-tool cooperative application 504 stores, in the form of array, manually-changeable setting items in the RAM 413. The manually-changeable setting items refer to setting items whose setting values, which are not supported by the MFP 120, are set in the scan-job setting information and which have selectable values other than the set setting values. For example, the setting values of the sheet size supported by the MFP 120 are A4, A5, and A6, while the setting value of the sheet size of the scan-job setting information is A3 size. In this case, a user may manually change the setting to any of A4, A5, and A6 to perform scanning. Such a setting item is defined as a manually-changeable setting item.

In S1612, the collaboration-tool cooperative application 504 determines whether one or more pieces of data are present in the array of the manually-changeable setting items. If it is determined that one or more pieces of data are present, the process proceeds to S1614. If it is determined that one or more pieces of data are not present, the process proceeds to S1613.

In S1613, the collaboration-tool cooperative application 504 displays an automatic replacement screen 1750 in FIG. 17G. The automatic replacement screen 1750 displays a pop-up screen 1751 on the scan setting screen 1740. The pop-up screen 1751 has a message 1752, a cancel button 1754, and an execution-with-replacement button 1753. The message 1752 is a message for confirming that settings, which are not supported by the MFP 120, are set in the scan-job setting information and whether the setting values are to be replaced to perform scanning.

In S1614, the collaboration-tool cooperative application 504 displays a manual replacement screen 1760 in FIG. 17H. The manual replacement screen 1760 displays a pop-up screen 1761 on the scan setting screen 1740. The pop-up screen 1761 has a message 1762, an execution-with-replacement button 1765, a manual change button 1764, and a cancel button 1763. The message 1762 is a message for confirming that settings, which are not supported by the MFP 120, are set in the scan-job setting information and whether the setting values are to be replaced to perform scanning.

In S1615, the collaboration-tool cooperative application 504 determines which button, which is displayed in the pop-up screen in S1613 or S1614, has been pressed. If the OK button 1753 or 1765 has been pressed, the process proceeds to S1616. If the manual change button 1764 has been pressed, the process proceeds to S1617. If the cancel button 1754 or 1763 has been pressed, the process of the flowchart ends.

In S1616, the collaboration-tool cooperative application 504 changes the setting values, which are not supported by the MFP 120, to the defaults or nulls, and updates the scan-job setting information. Steps S1617 to S1620 are repeatedly performed until the condition of S1621 is satisfied. Thus, the setting values of the setting items, which are not supported by the MFP 120, may be changed by a user.

In S1617, the collaboration-tool cooperative application 504 retrieves a piece of setting item data from the array of the manually-changeable setting items on the RAM 413.

In S1618, the collaboration-tool cooperative application 504 displays a pop-up screen 1781 for changing the setting of the setting item data retrieved in S1617. The pop-up screen 1781 is an exemplary screen for changing the setting value of the sheet size, and is displayed on the scan setting screen 1740. The pop-up screen 1781 includes an A4 button 1782, an A5 button 1783, and an A6 button 1784.

In S1619, the collaboration-tool cooperative application 504 determines whether a button 1782, 1783, or 1784 for the various setting values in the pop-up screen displayed in S1618 has been pressed. It is determined that a button has been pressed, the process proceeds to S1620. If it is determined that a button has not been pressed, the process proceeds to S1618.

In S1620, the collaboration-tool cooperative application 504 updates the scan-job setting information, which is stored in the RAM 413, with the pressed setting value.

In S1621, the collaboration-tool cooperative application 504 determines whether the array of the manually-changeable setting items is null. If it is determined that the array is null, the process proceeds to S1622. If it is determined that the array is not null, the process proceeds to S1617.

In S1622, the collaboration-tool cooperative application 504 displays a scan-in-progress screen 1790. The scan-in-progress screen 1790 displays a pop-up screen 1791 on the scan setting screen 1740.

In S1623, the collaboration-tool cooperative application 504 instructs the scanner controller 505 to perform scanning. The scanner controller 505 performs scanning and stores the scan result file in the HDD 414.

In S1624, the collaboration-tool cooperative application 504 obtains the scan result file stored in the HDD 414 in S1623. The collaboration-tool cooperative application 504 converts the obtained scan result file to the file format 1520 included in the scan-job setting information, and stores the resulting file in the HDD 414.

In S1625, the collaboration-tool cooperative application 504 transmits the scan result file, which is obtained through the conversion in S1624, as a scan completion event to the event processing application 702 of the collaboration-tool information management server 130.

In S1626, the collaboration-tool cooperative application 504 closes the pop-up screen 1791.

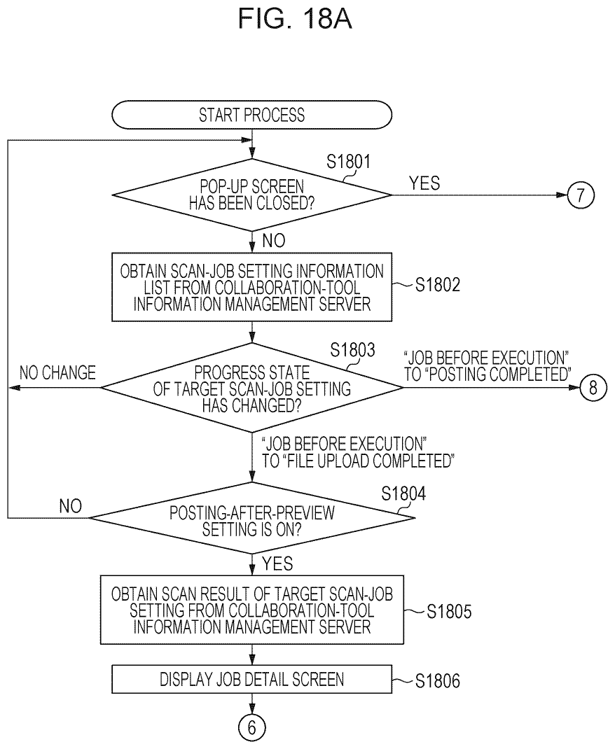

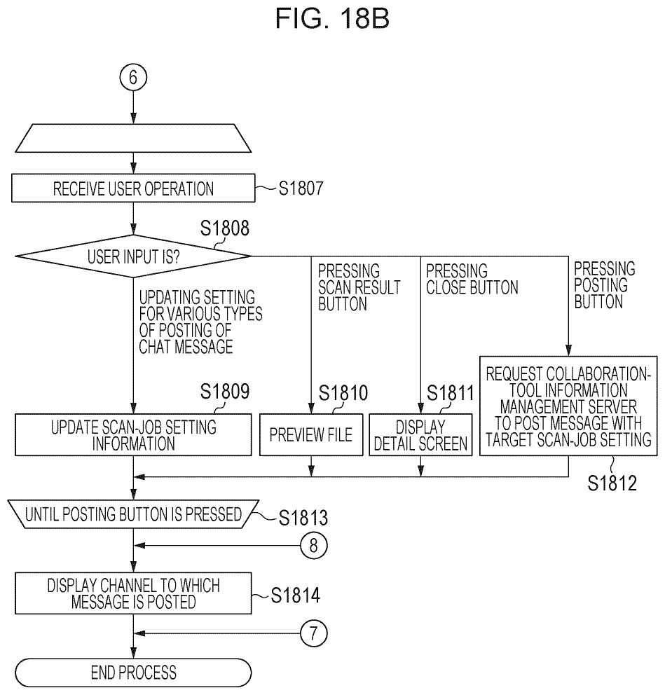

FIGS. 18A and 18B are a flowchart of an exemplary process performed so that the collaboration tool application 301 of the information processing apparatus 110 opens a posting-destination chat on the Web application 701. The flowchart starts in response to completion of the process in S926.

In S1801, the collaboration tool application 301 determines whether the pop-up screen 1220, which includes the message 1221 for prompting scanning using the MFP 120, has been closed. The pop-up screen 1220 is illustrated in FIG. 12B, and is displayed in S926 in FIG. 9B. If the determination result in S1801 is NO, the process proceeds to S1802. If the determination result is YES, the process of the flowchart ends.

In S1802, the collaboration tool application 301 obtains job list information from the collaboration-tool information management server 130, and proceeds to S1803.

In S1803, the collaboration tool application 301 obtains, from the job list obtained in S1802, scan-job setting information, whose job ID matches that received when the job is registered in the collaboration-tool information management server 130 in S916, and stores the scan-job setting information in the RAM 203. The collaboration tool application 301 checks (monitors) a change of the progress state 1514 of the scan-job setting information, and determines in which state the scan-job setting information is.

Specifically, when the process in S1803 is the first process after start of the flowchart, the collaboration tool application 301 determines that the progress state 1514 is information indicating “no change”, and proceeds to S1801.

In S1803, when the process in S1803 is the second or subsequent process after start of the flowchart, and when the progress state 1514 has changed from information indicating “job before execution” to information indicating “file upload completed”, it is determined that the progress state 1514 has changed to information indicating “file upload completed”, and the process proceeds to S1804. In S1803, when the process in S1803 is the second or subsequent process after start of the flowchart, and when the progress state 1514 has changed from information indicating “job before execution” to information indicating “posting completed”, it is determined that the progress state 1514 has changed to information indicating “posting completed”, and the process proceeds to S1814. Information indicating “posting completed” is information indicating the state in which scan data has been posted to the predetermined posting destination.

In S1804, the collaboration tool application 301 determines whether the posting-after-preview setting 1509 of the scan-job setting information is ON. If the determination result in S1804 is YES, the process proceeds to S1805. If the determination result is NO, the process proceeds to S1801.

In S1805, the collaboration tool application 301 requests the collaboration-tool information management server 130 to obtain the scan result file, and proceeds to S1806.

In S1806, the collaboration tool application 301 displays the job detail screen 1900, and proceeds to S1807. Steps S1807 to S1812 after that are repeatedly performed until the condition in S1813 is satisfied. A user may confirm and change various settings about posting of a chat message, which are displayed in the job detail screen. Pressing a scan result button 1907 enables the scan result file to be previewed.

In S1807, the collaboration tool application 301 receives a user operation on the job detail screen 1900 or the preview screen 1909, and proceeds to S1808.

In S1808, the collaboration tool application 301 determines which input has been received in S1807. If the input is for updating various settings for posting a chat message, the process proceeds to S1809. If the input is pressing the scan result button, the process proceeds to S1810. If the input is pressing a close button, the process proceeds to S1811. If the input is pressing the posting button, the process proceeds to S1812.

In S1809, the collaboration tool application 301 updates the scan-job setting information with the setting for posting a chat message, which is input by the user, and proceeds to S1813.

In S1810, the collaboration tool application 301 displays the preview screen 1909 to display the scan result obtained in S1805, and proceeds to S1813.

In S1811, the collaboration tool application 301 displays the job detail screen 1900, and proceeds to S1813.

In S1812, the collaboration tool application 301 uses the scan-job setting information, which is stored in the RAM 203 in S1803, to request the collaboration-tool information management server 130 to post a message, and proceeds to S1813.

In S1813, the collaboration tool application 301 determines whether the user input in S1808 is pressing the posting button. If the input is pressing the posting button, the process proceeds to S1814. If not, the process proceeds to S1807.

In S1814, the collaboration tool application 301 performs display control for displaying a screen (the after-posting-message screen 2020) including the predetermined posting destination to which the scan data has been posted, on the basis of the posting-destination channel ID or the posting-destination user ID included in the scan-job setting information. Then, the collaboration tool application 301 ends the process of the flowchart. In the embodiment described above, before scan data is posted to a predetermined posting destination, a preview image of the scan data is displayed on the collaboration tool. After display of the preview image of the scan data, a posting instruction is received. Thus, the scan data is posted to the predetermined posting destination.

Thus, when scan data which is not intended by a user is generated, occurrence of posting the unintended scan data automatically to a predetermined posting destination on the collaboration tool may be reduced.

### Second Embodiment

In the first embodiment, the initial display condition of the posting-destination team 1204 and the posting-destination channel 1205 which are displayed as a posting destination in the scan job setting area in FIG. 12A is the most-commonly-posted destination of a login user. However, the most-commonly-posted destination may be a posting destination different from one desired by a user, and the user may have a desired posting destination other than the initial posting destination. Further, a user may want to sort, for display, a posting-destination list, from which a setting value is selectable, on the basis of a predetermined condition. Accordingly, in the second embodiment, the initial display condition of the posting-destination team 1204 and the posting-destination channel 1205 is made changeable. In addition, the posting-destination list may be sorted, for display, on the basis of a predetermined condition.

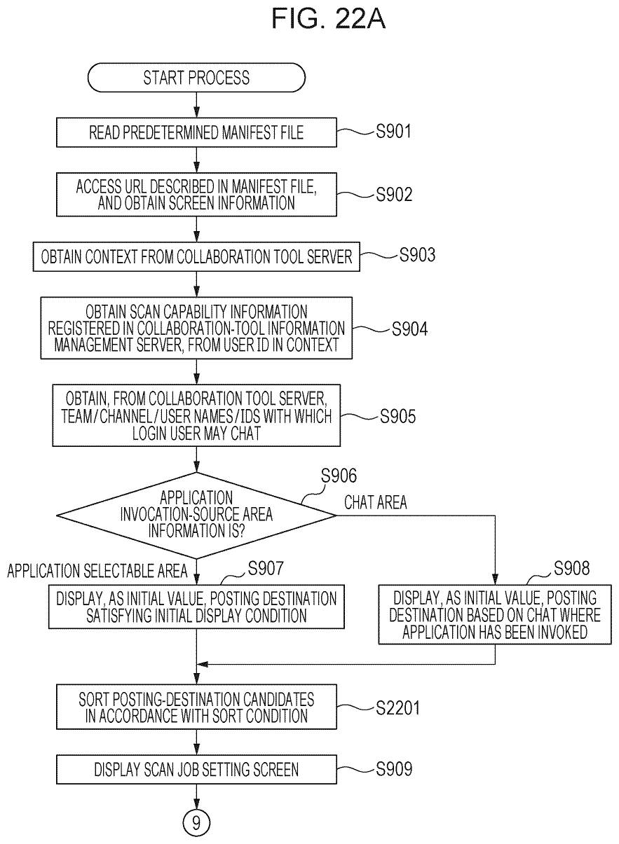

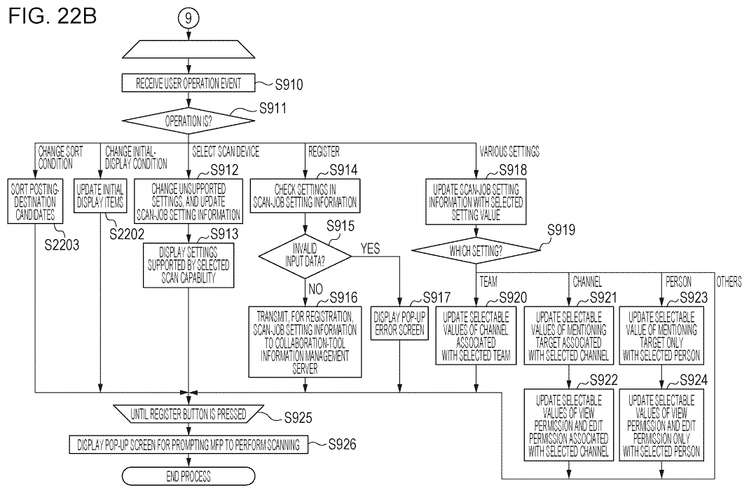

FIGS. 22A and 22B are a flowchart obtained by changing a part of the process, in FIGS. 9A and 9B, performed so as to display job settings.

Steps S901 to S926 in FIGS. 22A and 22B are substantially the same as steps S901 to S926 in FIGS. 9A and 9B. The processes different from those in FIGS. 9A and 9B are a posting-destination candidate sorting process S2201, which is added between S907/S908 and S909, an initial-display-condition changing process S2202, which is an additional process, and a posting-destination candidate sorting process S2203, which is an additional process.

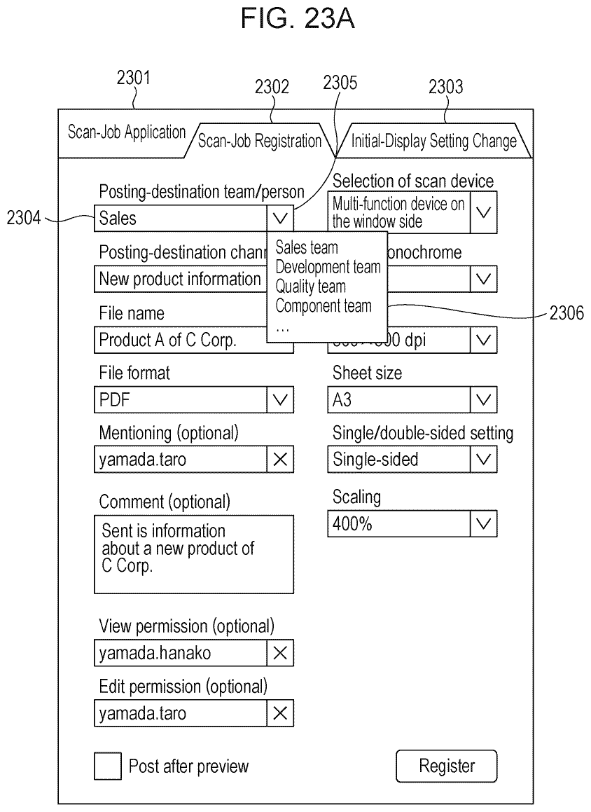

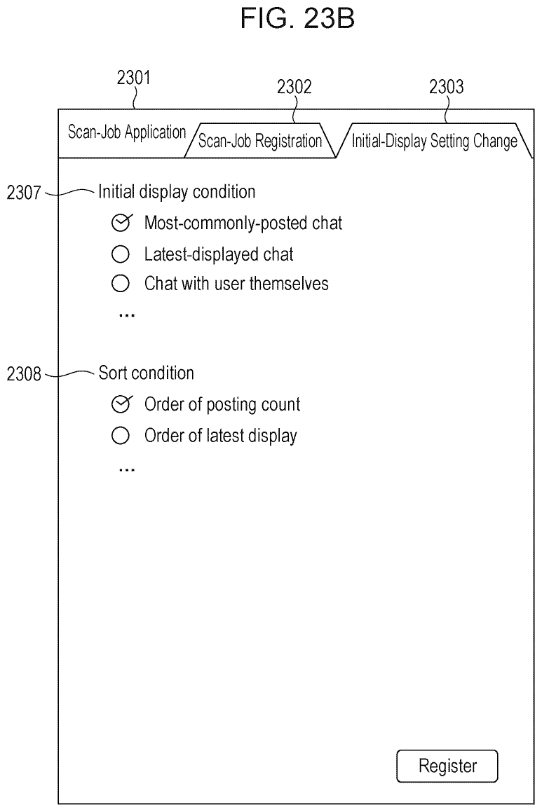

FIGS. 23A and 23B are diagrams illustrating an exemplary scan-job application screen 2301 displayed on the display unit 206 of the information processing apparatus 110. The scan-job application screen 2301, a scan job setting area 2302, and a posting-destination team 2304 in FIG. 23A are substantially the same as the scan-job application screen 1201, the scan job setting area 1202, and the posting-destination team 1204, respectively, in FIG. 12A. In FIG. 23A, selection of a posting-destination list display button 2305 causes information about teams/persons other than “Sales”, which is initially displayed in the posting-destination team 2304, to be displayed as a posting-destination list 2306. For example, when a given posting destination is selected from the posting destinations displayed in the posting-destination list 2306, information about the team/person selected in the posting-destination list 2306 is displayed in the posting-destination team 2304 instead of “Sales” which is initially displayed. When an initial-display setting change 2303 in FIG. 23B is selected, an area (FIG. 23B) including an initial-display-condition change button 2307 and a sort-condition change button 2308 is displayed. The initial-display-condition change button 2307 and the sort-display-condition change button 2308 are radio buttons.

Therefore, user events received in S910 in FIG. 23A include, in addition to the user events received in S910 in FIG. 9B, pressing of the initial-display-condition change button 2307 and pressing of the sort-condition change button 2308.

A specific process is illustrated in the flowchart in FIGS. 22A and 22B. The flowchart starts when predetermined user information is used to log in the collaboration tool application 301 on the information processing apparatus 110, and the plug-in application start button 2013 or 2015 is then pressed. The configurations and processes, which are not described in the description below, are equivalent to those in the first embodiment, and will not be described.

In S2201, the collaboration tool application 301 sorts, for display, the posting-destination list 2306 in accordance with a sort condition (predetermined condition) described below. The posting-destination list displayed in the posting-destination list 2306 in FIG. 23A is the same as that obtained in S905.

In S911 in FIG. 22B, if the collaboration tool application 301 receives an initial-display-condition change event, the process proceeds to S2202. If the collaboration tool application 301 receives a sort-condition change event, the process proceeds to S2203.

In S2202, the collaboration tool application 301 obtains information about the login user's usage of the collaboration tool application 301 from the collaboration-tool information management server 130. Then, on the basis of the obtained usage information, the collaboration tool application 301 updates, for display, the posting-destination team 2304 with a posting destination which satisfies the condition selected by using the initial-display-condition change button 2307. Options selectable by using the initial-display-condition change button 2307 may be, but not limited to these, for example, a chat of most-commonly-posted destination, a latest-displayed chat, and a chat with the user themselves. The latest-displayed chat is a chat displayed the latest before display of the scan-job application screen 2301. The chat with the user themselves is a chat in which user information, which indicates a user who has logged in the collaboration tool application 301, may post a message to the user themselves (that is, the logged-in user information).

In S2203, the collaboration tool application 301 obtains information of the login user's usage of the collaboration tool application 301 from the collaboration-tool information management server 130. Then, the collaboration tool application 301 updates, for display, the order of the posting destinations in the posting-destination list on the basis of the obtained usage information and the condition selected by using the sort-condition change button 2308. Order options selectable by using the sort-condition change button 2308 may be, but not limited to these, for example, the order of posting count and the order of latest display. Display in the order of posting count refers to display in the descending order starting from the posting destination (most-commonly-posted destination) whose count of the logged-in user's posts of scan data is the most. Display in the order of latest display refers to display in the order starting from the posting destination displayed the latest before display of the scan-job application screen 2301.

As described above, in the present embodiment, the initial display condition of the posting-destination team 1204 and the posting-destination channel 1205 displayed as an initial posting destination in the scan job setting area in FIG. 12A is changeable. In addition, the posting-destination list may be sorted, for display, on the basis of a predetermined condition. Thus, a user may select a more desirable posting destination. Even with a large number of posting destination options, trouble in selecting a posting destination may be mitigated, achieving improvement of user convenience.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-165667, filed Sep. 27, 2023 and No. 2023-165668, filed Sep. 27, 2023, which are hereby incorporated by reference herein in their entirety.

What is claimed is:

1. A control method for an information processing apparatus, the information processing apparatus being capable of communicating with a server, the server being capable of communicating with an image processing apparatus, the method comprising:
receiving setting of information about scanning;
transmitting, to the server, scan-job setting information based on the received setting of information about scanning; and
acquiring scan data from the server, the scan data being generated through the scanning performed by the image processing apparatus based on the scan-job setting information,
wherein the acquired scan data is displayed in a predetermined area on a display unit of the information processing apparatus.

2. The control method according to claim 1, the process further comprising:
receiving, from a user, a posting instruction to post the scan data to a predetermined posting destination, the scan data being displayed in the predetermined area,
wherein the scan data is posted to the predetermined posting destination based on the received posting instruction.

3. The control method according to claim 2,
wherein the scan data is displayed in the predetermined area before being posted to the predetermined posting destination.

4. The control method according to claim 3, the process further comprising:
receiving, at the information processing apparatus, an instruction to post the scan data to the predetermined posting destination after the scan data is displayed in the predetermined area,
wherein, in response to reception of the instruction in the receiving at the information processing apparatus, the scan data is displayed in the predetermined area before being posted to the predetermined posting destination.

5. The control method according to claim 2,
wherein the predetermined area is a preview display area, and the scan data is displayed in the preview display area before the reception of the posting instruction.

6. The control method according to claim 5,
wherein, when a setting of preview display of the scan data in the preview display area is set, the acquired scan data is displayed in the predetermined area of the display unit of the information processing apparatus.

7. The control method according to claim 5,
wherein, when a setting of preview display of the scan data in the preview display area is not set, the acquired scan data is not displayed in the predetermined area of the display unit of the information processing apparatus, and is posted to a predetermined posting destination.

8. The control method according to claim 1,
wherein the scan data is transmitted from the image processing apparatus to the server, and is then temporarily stored in the server.

9. The control method according to claim 2,
wherein the scan data is posted to the predetermined posting destination by the server transmitting, to an external server, an instruction to post the scan data to the posting destination, the server obtaining, from the information processing apparatus, an instruction based on the received posting instruction, the external server posting the scan data to the posting destination.

10. A storage medium storing a program causing a computer of an information processing apparatus to perform a process, the information processing apparatus being capable of communicating with a server, the server being capable of communicating with an image processing apparatus, the process comprising:
receiving setting of information about scanning;
transmitting, to the server, scan-job setting information based on the received setting of information about scanning; and
acquiring scan data from the server, the scan data being generated through the scanning performed by the image processing apparatus based on the scan-job setting information,
wherein the acquired scan data is displayed in a predetermined area on a display unit of the information processing apparatus.

11. A system including an information processing apparatus, an image processing apparatus, and a server, the image processing apparatus being different from the information processing apparatus, the server being capable of communicating with the information processing apparatus and the image processing apparatus, the system comprising:
the information processing apparatus including
a first reception unit configured to receive setting of information about scanning,
a first transmission unit configured to transmit, to the server, scan-job setting information based on the setting of information about scanning, the setting of information about scanning being received by the first reception unit, and
a first acquisition unit configured to acquire scan data from the server, the scan data being generated through the scanning performed by the image processing apparatus based on the scan-job setting information;
the server including
a second acquisition unit configured to acquire the scan-job setting information,
a second transmission unit configured to transmit the scan-job setting information to the image processing apparatus,
a third acquisition unit configured to acquire the scan data, and
a third transmission unit configured to transmit the scan data to the information processing apparatus; and
the image processing apparatus including
a fourth acquisition unit configured to acquire the scan-job setting information,
an execution unit configured to perform the scanning based on the scan-job setting information, and
a fourth transmission unit configured to transmit the scan data to the server, the scan data being generated based on the scan-job setting information through the execution by the execution unit,
wherein the scan data is displayed in a predetermined area of a display unit of the information processing apparatus.
